(19) United States
(12) Patent Application Publication
(10) Pub. No.: US 2026/0367781 A1
(43) Pub. Date: Nov. 19, 2026

(54) VISUAL ANALYSIS USER INTERFACE

(71) Applicant: Apple Inc., Cupertino, CA (US)

(72) Inventors: Adrian ZUMBRUNNEN, San Francisco, CA (US); Johnnie B. MANZARI, San Francisco, CA (US)

(21) Appl. No.: 19/633,549

(22) Filed: Mar. 30, 2026

Related U.S. Application Data
(60) Provisional application No. 63/806,572, filed on May 15, 2025.

(51) Int. Cl. G06F 3/04883; G06F 3/0482; G06V 10/25; G06V 10/77; H04N 23/63

(52) U.S. Cl. CPC G06F 3/04883; G06F 3/0482; G06V 10/25; G06V 10/7715; H04N 23/632; G06V 2201/07

(57) ABSTRACT

The present disclosure generally relates to methods and interfaces for interacting with visual content. In some examples, a computer system displays a prompt to indicate a region of interest within visual content and, if a gesture is not detected, conditionally displays indications of one or more automatically-detected features of interest within the visual content. In some examples, in response to a request for additional information about a feature of interest within visual content, a computer system displays a user interface with information related to visual analysis operations and an option for selecting a visual analysis service provider.

### CROSS-REFERENCE TO RELATED APPLICATIONS

This application claims priority to U.S. Provisional Patent Application No. 63/806,572, entitled “VISUAL ANALYSIS USER INTERFACE”, filed on May 15, 2025. The content of this application is hereby incorporated by reference in its entirety.

### FIELD

The present disclosure relates generally to computer user interfaces, and more specifically to techniques for performing visual analysis operations.

### BACKGROUND

Electronic devices such as smart phones, tablets, and wearable devices, provide user interfaces for interacting with visual content, such as visual content from one or more cameras (e.g., a live or near-live camera feed), displayed visual content (e.g., screen captures and/or screen recordings), and/or stored visual content (e.g., media items in a media library). Example user interfaces include options for composing, capturing, viewing, modifying, and/or analyzing visual content via the electronic devices.

### BRIEF SUMMARY

Some techniques for performing visual analysis operations using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for performing visual analysis operations. Such methods and interfaces optionally complement or replace other methods for performing visual analysis operations. Such methods and interfaces reduce the cognitive burden on a user and produce a more efficient human-machine interface. For battery-operated computing devices, such methods and interfaces conserve power and increase the time between battery charges. Such methods reduce processing power, memory usage, and number of inputs needed for visual analysis operations.

In accordance with some embodiments, a method performed at a computer system that is in communication with one or more display generation components and one or more input devices is described. The method includes: while displaying, via the one or more display generation components, visual content, wherein at least one visual analysis operation is available to be performed on the visual content: displaying, via the one or more display generation components, a prompt to use a gesture input to indicate a region of interest within the visual content; and in accordance with a determination that a respective set of criteria is satisfied, displaying, via the one or more display generation components, an indication of one or more features detected within the visual content, wherein: the respective set of criteria includes a first criterion that is satisfied when a respective gesture input indicating a respective region of interest within the visual content has not been detected via the one or more input devices for at least a threshold amount of time since the visual content was displayed; and the respective set of criteria includes a requirement that the first criterion is satisfied in order for the respective set of criteria to be satisfied.

In accordance with some embodiments, a non-transitory computer-readable storage medium is described. The non-transitory computer-readable storage medium stores one or more programs configured to be executed by one or more processors of a computer system that is in communication with one or more display generation components and one or more input devices, the one or more programs including instructions for: while displaying, via the one or more display generation components, visual content, wherein at least one visual analysis operation is available to be performed on the visual content: displaying, via the one or more display generation components, a prompt to use a gesture input to indicate a region of interest within the visual content; and in accordance with a determination that a respective set of criteria is satisfied, displaying, via the one or more display generation components, an indication of one or more features detected within the visual content, wherein: the respective set of criteria includes a first criterion that is satisfied when a respective gesture input indicating a respective region of interest within the visual content has not been detected via the one or more input devices for at least a threshold amount of time since the visual content was displayed; and the respective set of criteria includes a requirement that the first criterion is satisfied in order for the respective set of criteria to be satisfied.

In accordance with some embodiments, a transitory computer-readable storage medium is described. The transitory computer-readable storage medium stores one or more programs configured to be executed by one or more processors of a computer system that is in communication with one or more display generation components and one or more input devices, the one or more programs including instructions for: while displaying, via the one or more display generation components, visual content, wherein at least one visual analysis operation is available to be performed on the visual content: displaying, via the one or more display generation components, a prompt to use a gesture input to indicate a region of interest within the visual content; and in accordance with a determination that a respective set of criteria is satisfied, displaying, via the one or more display generation components, an indication of one or more features detected within the visual content, wherein: the respective set of criteria includes a first criterion that is satisfied when a respective gesture input indicating a respective region of interest within the visual content has not been detected via the one or more input devices for at least a threshold amount of time since the visual content was displayed; and the respective set of criteria includes a requirement that the first criterion is satisfied in order for the respective set of criteria to be satisfied.

In accordance with some embodiments, a computer system is described. The computer system is configured to communicate with one or more display generation components and one or more input devices, and the computer system comprises: means for, while displaying, via the one or more display generation components, visual content, wherein at least one visual analysis operation is available to be performed on the visual content: displaying, via the one or more display generation components, a prompt to use a gesture input to indicate a region of interest within the visual content; and in accordance with a determination that a respective set of criteria is satisfied, displaying, via the one or more display generation components, an indication of one or more features detected within the visual content, wherein: the respective set of criteria includes a first criterion that is satisfied when a respective gesture input indicating a respective region of interest within the visual content has not been detected via the one or more input devices for at least a threshold amount of time since the visual content was displayed; and the respective set of criteria includes a requirement that the first criterion is satisfied in order for the respective set of criteria to be satisfied.

In accordance with some embodiments, a computer system is described. The computer system is configured to communicate with one or more display generation components and one or more input devices, and the computer system comprises: one or more processors; and memory storing one or more programs configured to be executed by the one or more processors, the one or more programs including instructions for: while displaying, via the one or more display generation components, visual content, wherein at least one visual analysis operation is available to be performed on the visual content: displaying, via the one or more display generation components, a prompt to use a gesture input to indicate a region of interest within the visual content; and in accordance with a determination that a respective set of criteria is satisfied, displaying, via the one or more display generation components, an indication of one or more features detected within the visual content, wherein: the respective set of criteria includes a first criterion that is satisfied when a respective gesture input indicating a respective region of interest within the visual content has not been detected via the one or more input devices for at least a threshold amount of time since the visual content was displayed; and the respective set of criteria includes a requirement that the first criterion is satisfied in order for the respective set of criteria to be satisfied.

In accordance with some embodiments, a computer program product is described. The computer program product is configured to be executed by one or more processors of a computer system that is in communication with one or more display generation components and one or more input devices, the one or more programs including instructions for: while displaying, via the one or more display generation components, visual content, wherein at least one visual analysis operation is available to be performed on the visual content: displaying, via the one or more display generation components, a prompt to use a gesture input to indicate a region of interest within the visual content; and in accordance with a determination that a respective set of criteria is satisfied, displaying, via the one or more display generation components, an indication of one or more features detected within the visual content, wherein: the respective set of criteria includes a first criterion that is satisfied when a respective gesture input indicating a respective region of interest within the visual content has not been detected via the one or more input devices for at least a threshold amount of time since the visual content was displayed; and the respective set of criteria includes a requirement that the first criterion is satisfied in order for the respective set of criteria to be satisfied.

In accordance with some embodiments, a method performed at a computer system that is in communication with one or more display generation components and one or more input devices is described. The method includes: detecting, via the one or more input devices, an input requesting additional information associated with a feature of interest within respective visual content; and in response to detecting the input requesting the additional information associated with the feature of interest within the respective visual content, displaying, via the one or more display generation components, a visual analysis user interface that includes concurrently displaying: information associated with performance of a respective visual analysis operation associated with the feature of interest within the respective visual content; and a first option that, when selected, initiates a process for changing a service provider for performing the respective visual analysis operation.

In accordance with some embodiments, a non-transitory computer-readable storage medium is described. The non-transitory computer-readable storage medium stores one or more programs configured to be executed by one or more processors of a computer system that is in communication with one or more display generation components and one or more input devices, the one or more programs including instructions for: detecting, via the one or more input devices, an input requesting additional information associated with a feature of interest within respective visual content; and in response to detecting the input requesting the additional information associated with the feature of interest within the respective visual content, displaying, via the one or more display generation components, a visual analysis user interface that includes concurrently displaying: information associated with performance of a respective visual analysis operation associated with the feature of interest within the respective visual content; and a first option that, when selected, initiates a process for changing a service provider for performing the respective visual analysis operation.

In accordance with some embodiments, a transitory computer-readable storage medium is described. The transitory computer-readable storage medium stores one or more programs configured to be executed by one or more processors of a computer system that is in communication with one or more display generation components and one or more input devices, the one or more programs including instructions for: detecting, via the one or more input devices, an input requesting additional information associated with a feature of interest within respective visual content; and in response to detecting the input requesting the additional information associated with the feature of interest within the respective visual content, displaying, via the one or more display generation components, a visual analysis user interface that includes concurrently displaying: information associated with performance of a respective visual analysis operation associated with the feature of interest within the respective visual content; and a first option that, when selected, initiates a process for changing a service provider for performing the respective visual analysis operation.

In accordance with some embodiments, a computer system is described. The computer system is configured to communicate with one or more display generation components and one or more input devices, and the computer system comprises: means for detecting, via the one or more input devices, an input requesting additional information associated with a feature of interest within respective visual content; and means for, in response to detecting the input requesting the additional information associated with the feature of interest within the respective visual content, displaying, via the one or more display generation components, a visual analysis user interface that includes concurrently displaying: information associated with performance of a respective visual analysis operation associated with the feature of interest within the respective visual content; and a first option that, when selected, initiates a process for changing a service provider for performing the respective visual analysis operation.

In accordance with some embodiments, a computer system is described. The computer system is configured to communicate with one or more display generation components and one or more input devices, and the computer system comprises: one or more processors; and memory storing one or more programs configured to be executed by the one or more processors, the one or more programs including instructions for: detecting, via the one or more input devices, an input requesting additional information associated with a feature of interest within respective visual content; and in response to detecting the input requesting the additional information associated with the feature of interest within the respective visual content, displaying, via the one or more display generation components, a visual analysis user interface that includes concurrently displaying: information associated with performance of a respective visual analysis operation associated with the feature of interest within the respective visual content; and a first option that, when selected, initiates a process for changing a service provider for performing the respective visual analysis operation.

In accordance with some embodiments, a computer program product is described. The computer program product is configured to be executed by one or more processors of a computer system that is in communication with one or more display generation components and one or more input devices, the one or more programs including instructions for: detecting, via the one or more input devices, an input requesting additional information associated with a feature of interest within respective visual content; and in response to detecting the input requesting the additional information associated with the feature of interest within the respective visual content, displaying, via the one or more display generation components, a visual analysis user interface that includes concurrently displaying: information associated with performance of a respective visual analysis operation associated with the feature of interest within the respective visual content; and a first option that, when selected, initiates a process for changing a service provider for performing the respective visual analysis operation.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for performing visual analysis operations, thereby increasing the effectiveness, efficiency, and user satisfaction with such devices. Such methods and interfaces may complement or replace other methods for performing visual analysis operations.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3A is a block diagram of an exemplary multifunction device with a display and a touch-sensitive surface in accordance with some embodiments.

FIGS. 3B-3G illustrate the use of Application Programming Interfaces (APIs) to perform operations.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6V illustrate user interfaces for performing visual analysis operations, in accordance with some embodiments.

FIG. 7 is a flow diagram of methods for providing multiple options for performing visual analysis operations on particular visual content, in accordance with some embodiments.

FIG. 8 is a flow diagram of methods for providing multiple service provider options for performing a particular visual analysis operation, in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for performing visual analysis operations. For example, an efficient user interface for performing visual analysis operations provides users with intuitive guidance and feedback on how to use the visual analysis operations and the available options therefor, reducing the time, power, and user effort needed to perform the desired visual analysis operations, without unnecessarily cluttering the display, which distracts from and/or obscures the visual content being analyzed. Such techniques can reduce the cognitive burden on a user who uses an electronic device to perform visual analysis operations, thereby enhancing productivity. Further, such techniques can reduce processor and battery power otherwise wasted on redundant or mistaken user inputs and/or inadvertent or undesirably configured performances of power-and time-intensive visual analysis operations.

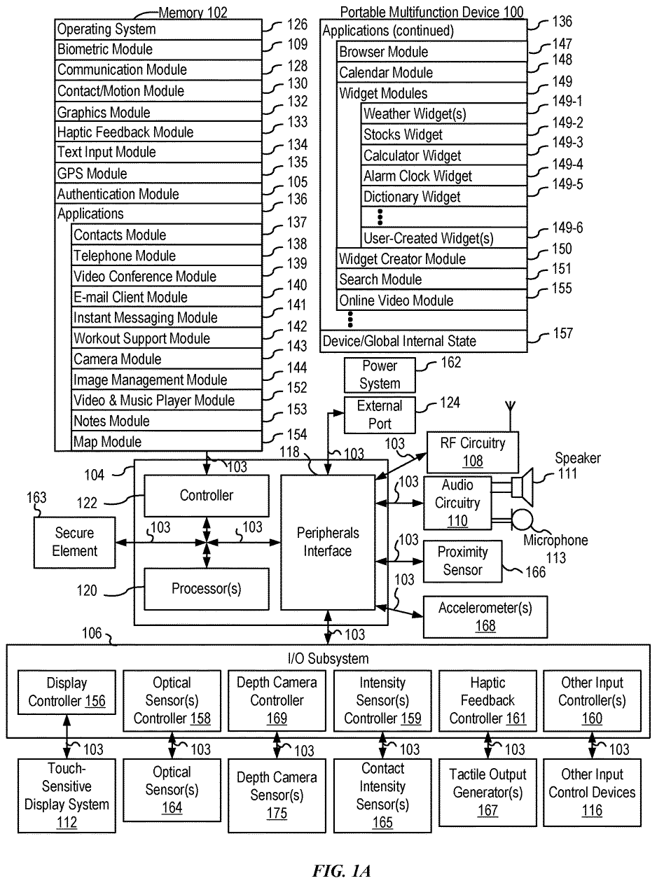

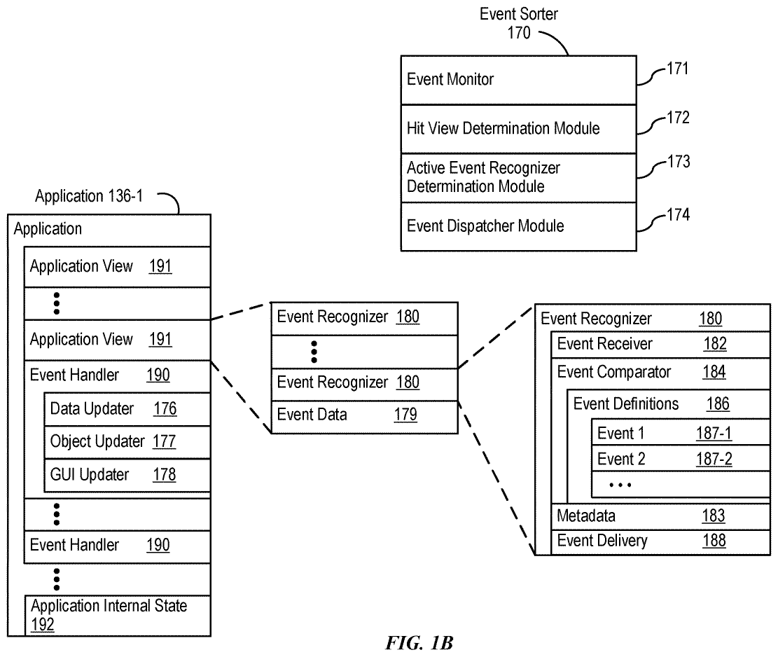

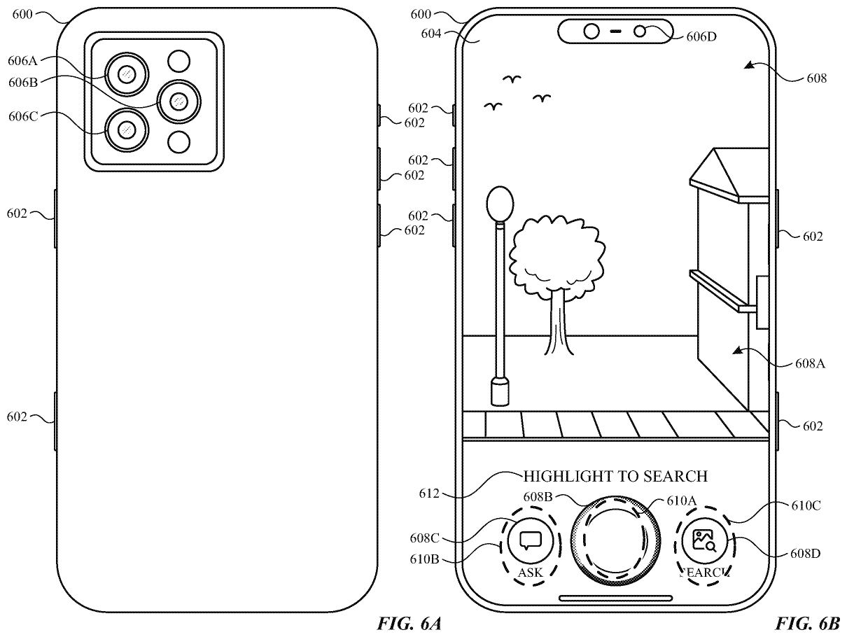

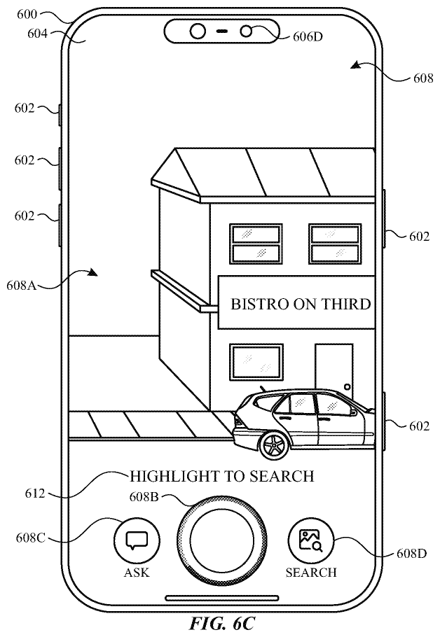

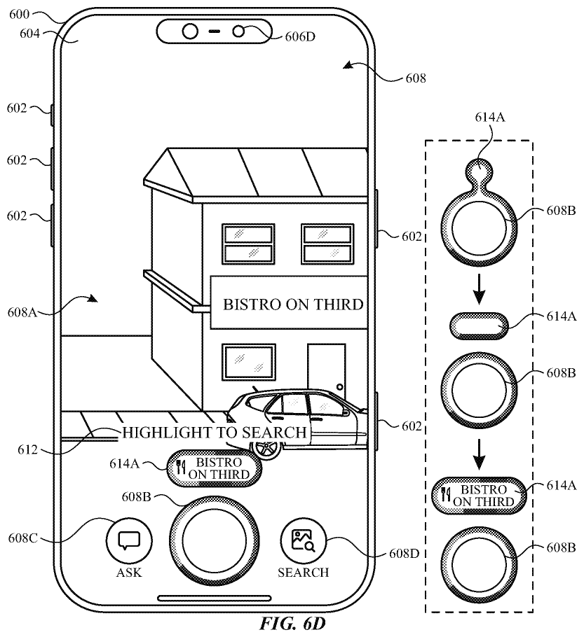

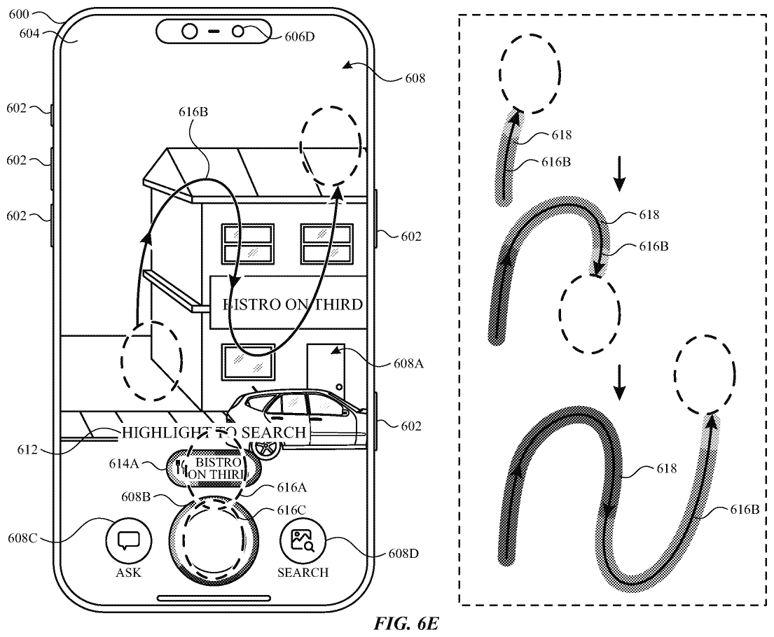

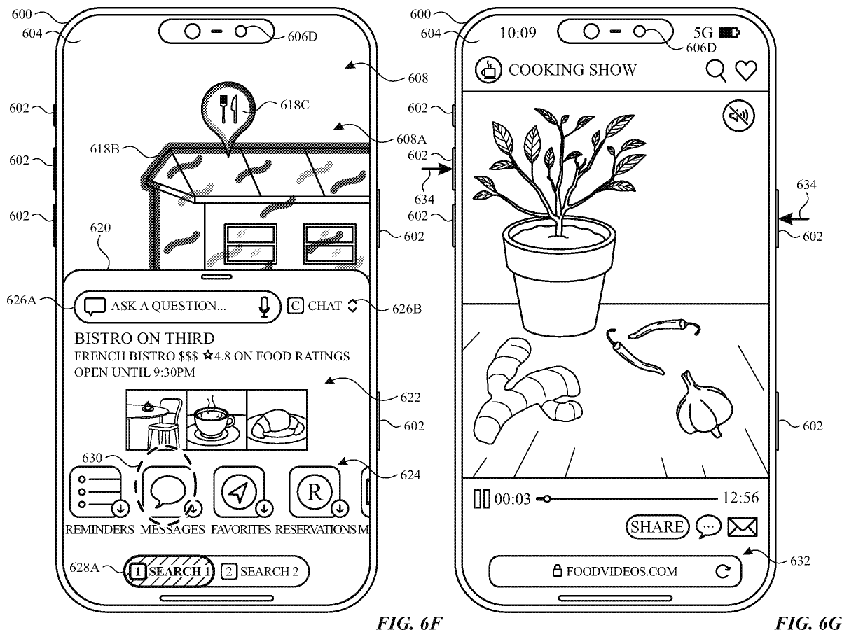

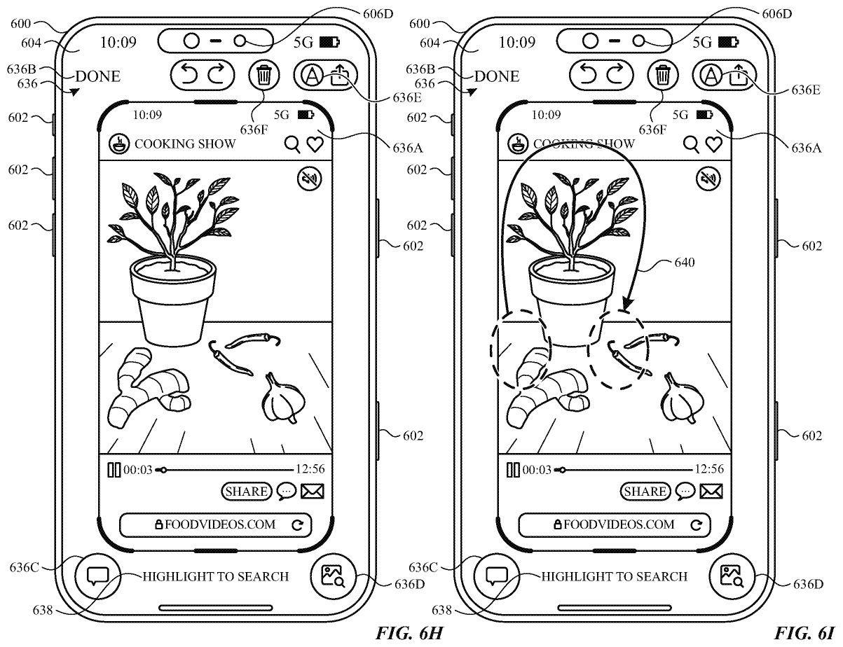

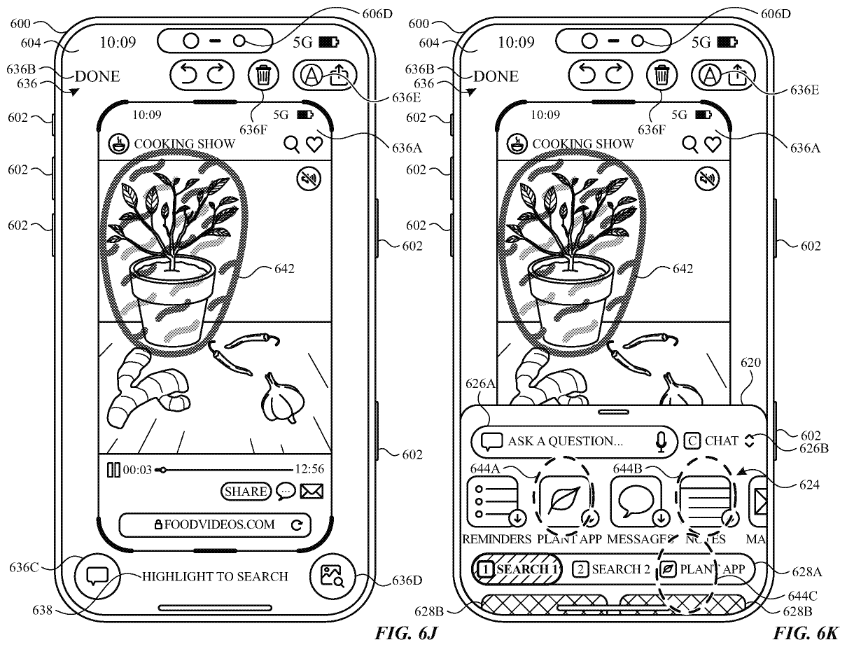

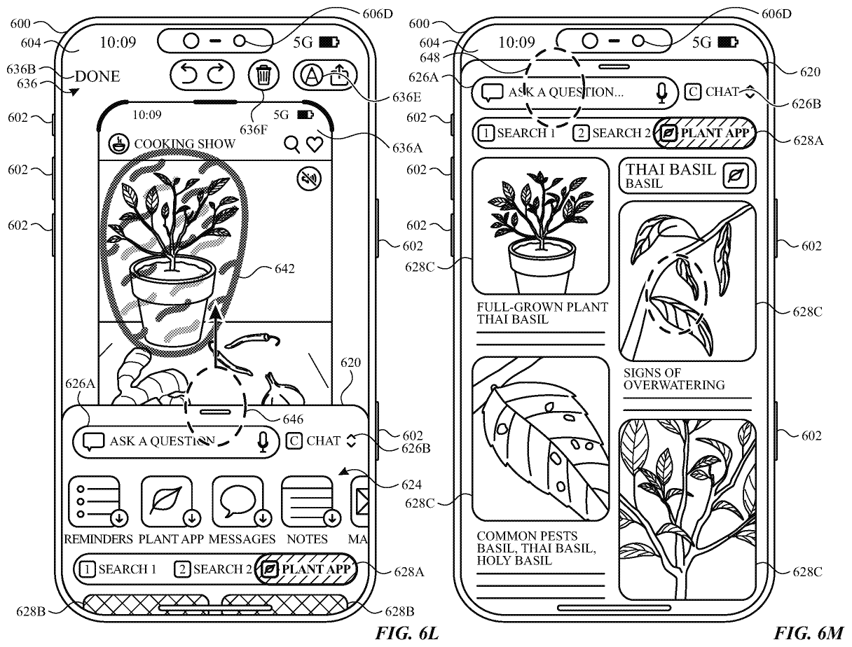

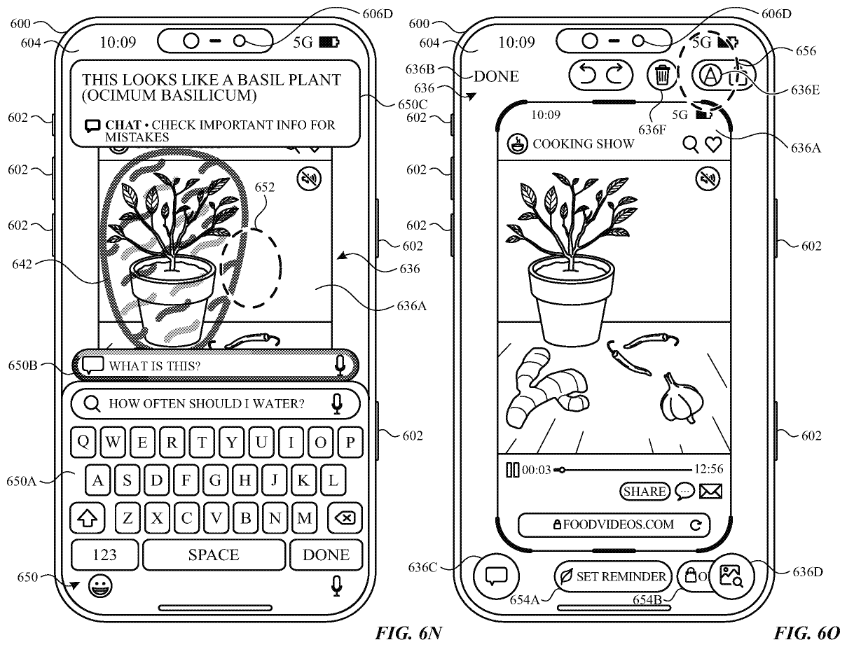

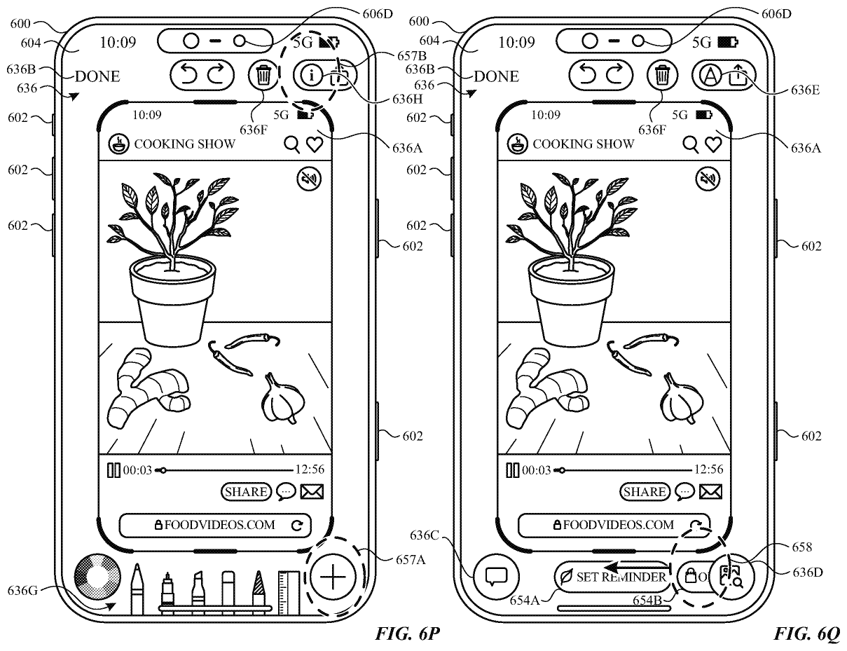

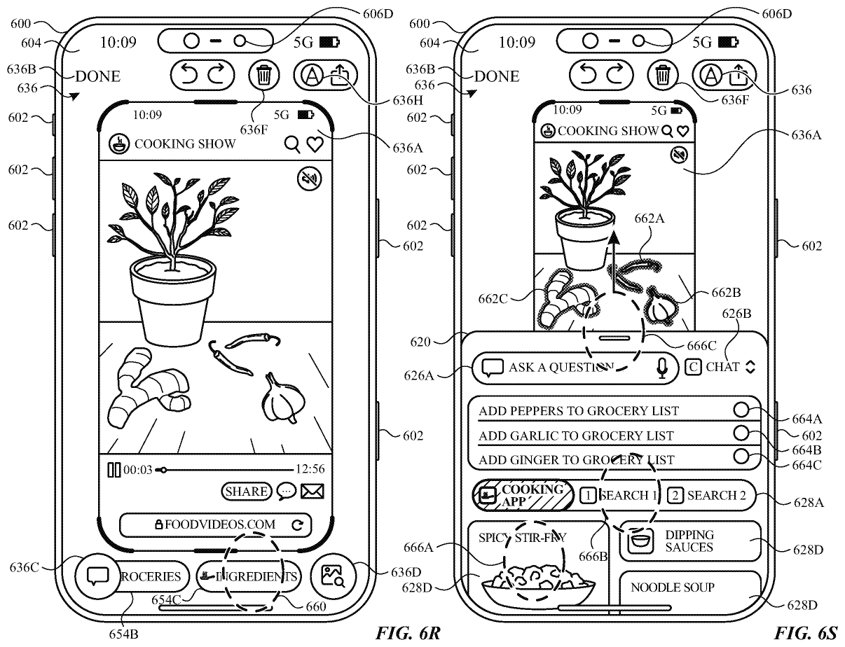

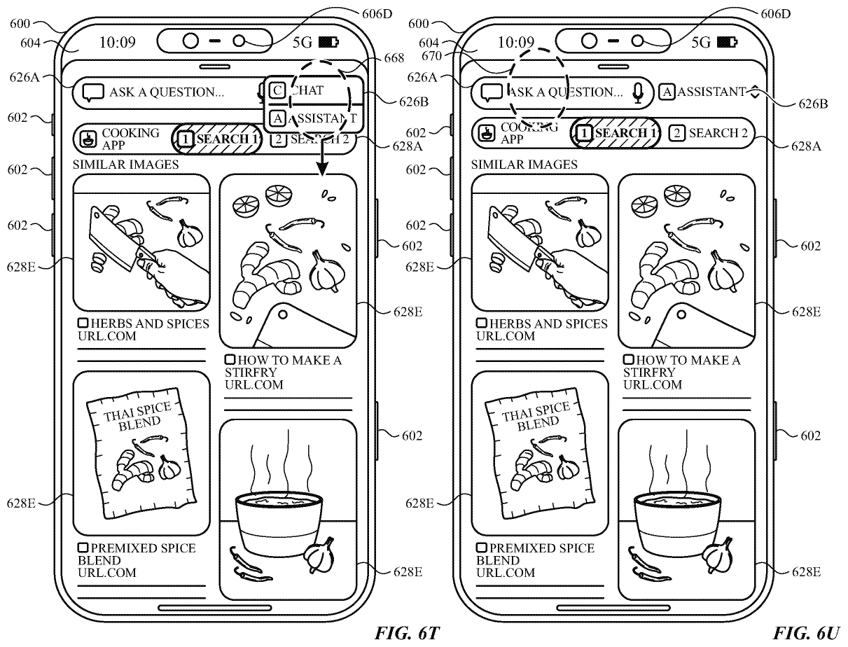

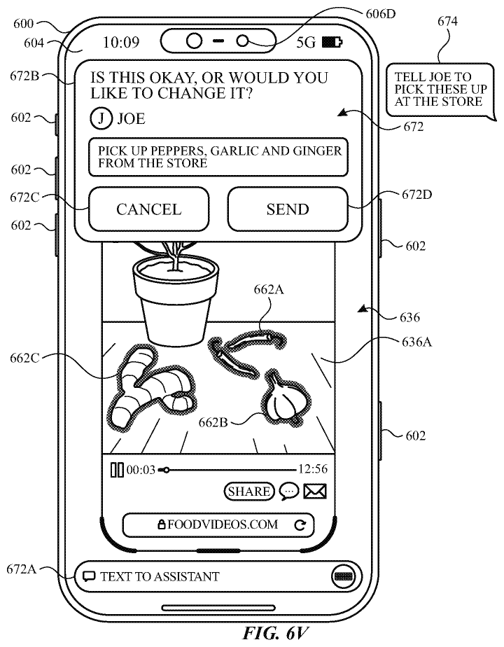

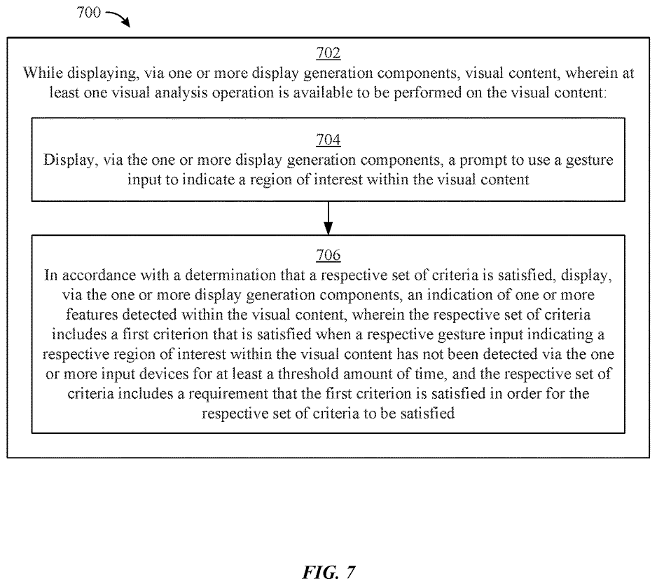

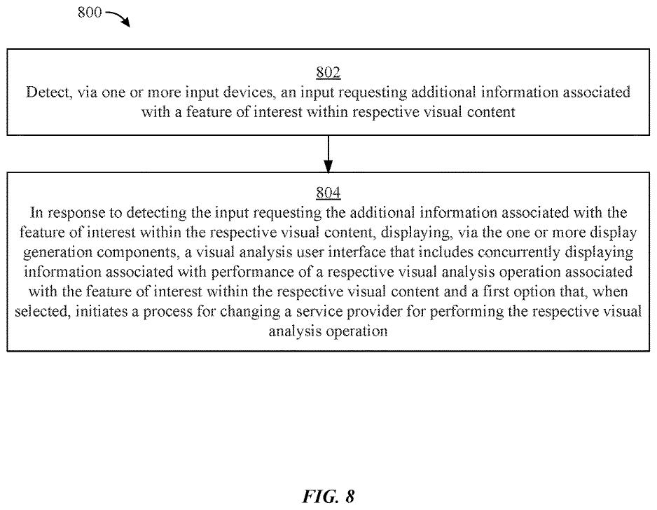

Below, FIGS. 1A-1B, 2, 3A-3G, 4A-4B, and 5A-5B provide a description of exemplary devices for performing the techniques for performing visual analysis operations. FIGS. 6A-6V illustrate exemplary user interfaces for performing visual analysis operations. FIG. 7 is a flow diagram illustrating methods for providing multiple options for performing visual analysis operations on particular visual content, in accordance with some embodiments. FIG. 8 is a flow diagram illustrating methods for providing multiple service provider options for performing a particular visual analysis operation, in accordance with some embodiments. The user interfaces in FIGS. 6A-6V are used to illustrate the processes described below, including the processes in FIGS. 7 and 8.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or providing the user with improved control over the security and privacy of displayed content. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

As used herein, the phrase “one or more of A and/or B” is construed to include all combinations of A and B, including, but not limited to: A individually without B; B individually without A; as well as a combination of A and B. The phrase “one or more of A, B, and/or C” is construed to include all combinations of A, B, and C, including, but not limited to: A individually without B and C; B individually without A and C; C individually without A and B; as well as any combinations of A, B, and/or C (e.g., A and B without C; A and C without B; B and C without A; and/or A, B, and C). Additionally, as used herein, the phrase “selected from the group consisting of A, B, C, and a combination thereof” and the phrase “at least one of A, B, and C” shall be construed to have the same meaning as the phrase “one or more of A, B, and/or C” as defined above. As used herein, the phrase “at least one of A, B, or C” and “one or more of A, B, or C” shall be construed to have the same meaning as the phrase “one or more of A, B, and/or C” as defined above. As used herein, the phrase “a combination including all of A, B, and C” is construed to include a combination of all the elements listed (e.g., a combination of A, B, and C).

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component (e.g., a display device such as a head-mounted display (HMD), a display, a projector, a touch-sensitive display, or other device or component that presents visual content to a user, for example on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage media), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

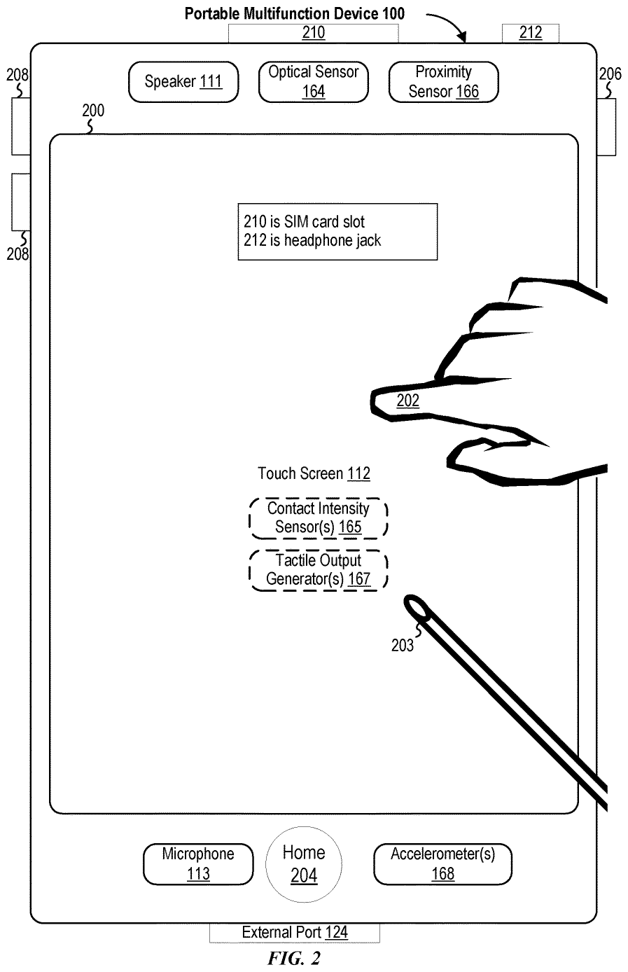

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes secure element 163 for securely storing information. In some embodiments, secure element 163 is a hardware component (e.g., a secure microcontroller chip) configured to securely store data or an algorithm. In some embodiments, secure element 163 provides (e.g., releases) secure information (e.g., payment information (e.g., an account number and/or a transaction-specific dynamic security code), identification information (e.g., credentials of a state-approved digital identification), and/or authentication information (e.g., data generated using a cryptography engine and/or by performing asymmetric cryptography operations)). In some embodiments, secure element 163 provides (or releases) the secure information in response to device 100 receiving authorization, such as a user authentication (e.g., fingerprint authentication; passcode authentication; detecting double-press of a hardware button when device 100 is in an unlocked state, and optionally, while device 100 has been continuously on a user's wrist since device 100 was unlocked by providing authentication credentials to device 100, where the continuous presence of device 100 on the user's wrist is determined by periodically checking that the device is in contact with the user's skin). For example, device 100 detects a fingerprint at a fingerprint sensor (e.g., a fingerprint sensor integrated into a button) of device 100. Device 100 determines whether the detected fingerprint is consistent with an enrolled fingerprint. In accordance with a determination that the fingerprint is consistent with the enrolled fingerprint, secure element 163 provides (e.g., releases) the secure information. In accordance with a determination that the fingerprint is not consistent with the enrolled fingerprint, secure element 163 forgoes providing (e.g., releasing) the secure information.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

In some embodiments, a depth map (e.g., depth map image) contains information (e.g., values) that relates to the distance of objects in a scene from a viewpoint (e.g., a camera, an optical sensor, a depth camera sensor). In one embodiment of a depth map, each depth pixel defines the position in the viewpoint's Z-axis where its corresponding two-dimensional pixel is located. In some embodiments, a depth map is composed of pixels wherein each pixel is defined by a value (e.g., 0-255). For example, the “0” value represents pixels that are located at the most distant place in a “three dimensional” scene and the “255” value represents pixels that are located closest to a viewpoint (e.g., a camera, an optical sensor, a depth camera sensor) in the “three dimensional” scene. In other embodiments, a depth map represents the distance between an object in a scene and the plane of the viewpoint. In some embodiments, the depth map includes information about the relative depth of various features of an object of interest in view of the depth camera (e.g., the relative depth of eyes, nose, mouth, ears of a user's face). In some embodiments, the depth map includes information that enables the device to determine contours of the object of interest in a z direction.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

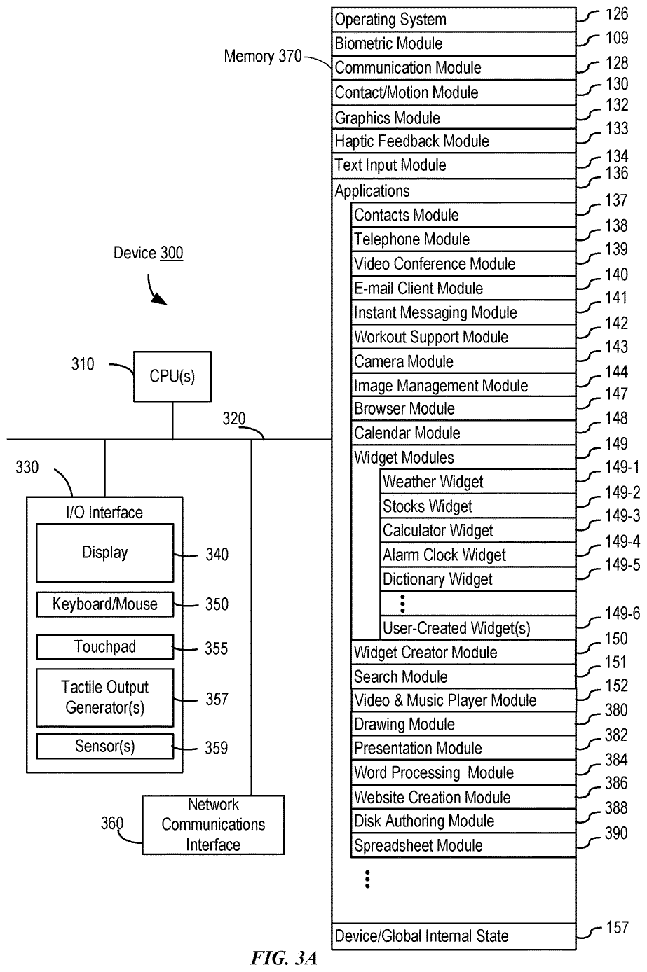

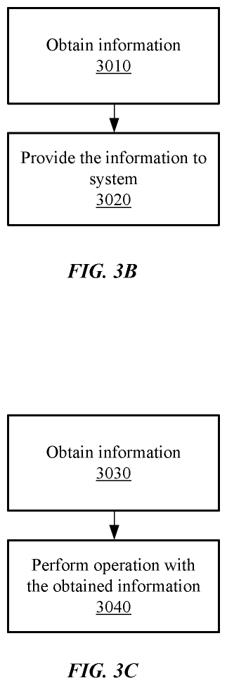

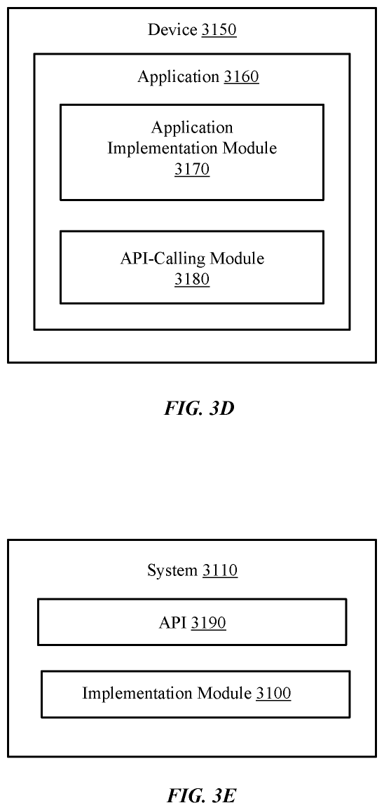

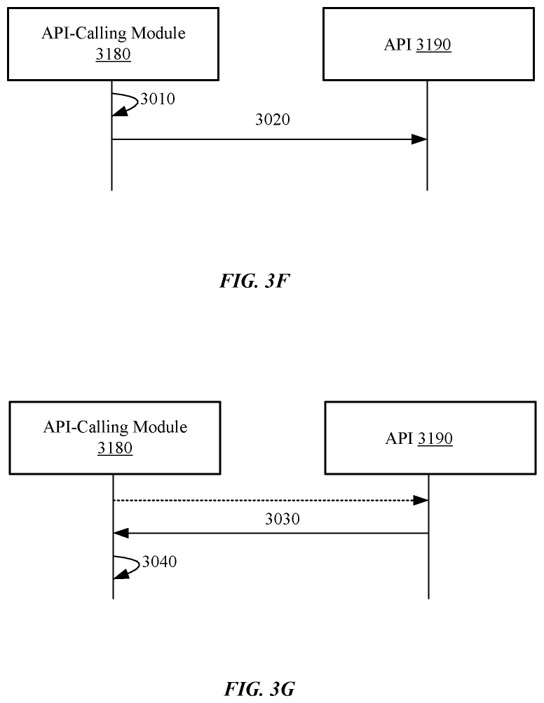

In some embodiments, the software components stored in memory 102 include operating system 126, biometric module 109, communication module (or set of instructions) 128, contact/motion module (or set of instructions) 130, graphics module (or set of instructions) 132, text input module (or set of instructions) 134, Global Positioning System (GPS) module (or set of instructions) 135, authentication module 105, and applications (or sets of instructions) 136. Furthermore, in some embodiments, memory 102 (FIG. 1A) or 370 (FIG. 3A) stores device/global internal state 157, as shown in FIGS. 1A and 3A. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE®, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Biometric module 109 optionally stores information about one or more enrolled biometric features (e.g., fingerprint feature information, facial recognition feature information, eye and/or iris feature information) for use to verify whether received biometric information matches the enrolled biometric features. In some embodiments, the information stored about the one or more enrolled biometric features includes data that enables the comparison between the stored information and received biometric information without including enough information to reproduce the enrolled biometric features. In some embodiments, biometric module 109 stores the information about the enrolled biometric features in association with a user account of device 100. In some embodiments, biometric module 109 compares the received biometric information to an enrolled biometric feature to determine whether the received biometric information matches the enrolled biometric feature.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch” multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing; to camera module 143 as picture/video metadata; and to applications that provide location-based services such as weather widgets, local yellow page widgets, and map/navigation widgets).

Authentication module 105 determines whether a requested operation (e.g., requested by an application of applications 136) is authorized to be performed. In some embodiments, authentication module 105 receives for an operation to be perform that optionally requires authentication. Authentication module 105 determines whether the operation is authorized to be performed, such as based on a series of factors, including the lock status of device 100, the location of device 100, whether a security delay has elapsed, whether received biometric information matches enrolled biometric features, and/or other factors. Once authentication module 105 determines that the operation is authorized to be performed, authentication module 105 triggers performance of the operation.

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript® file. In some embodiments, a widget includes an XML (Extensible Markup Language) file and a JavaScript® file (e.g., Yahoo!® Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3A is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform methods 700 and/or 800 (FIGS. 7 and/or 8) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module 3180) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

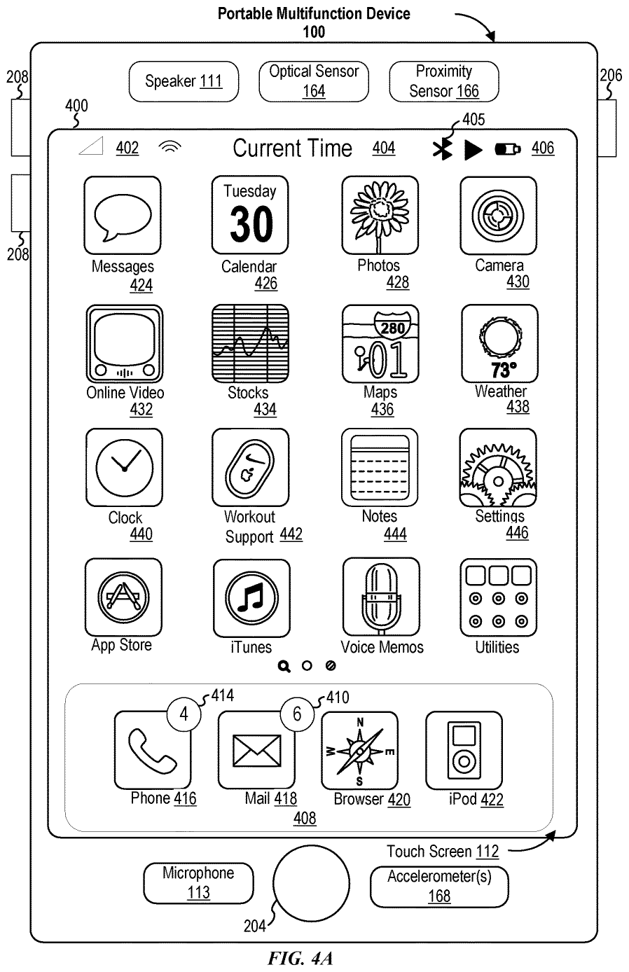

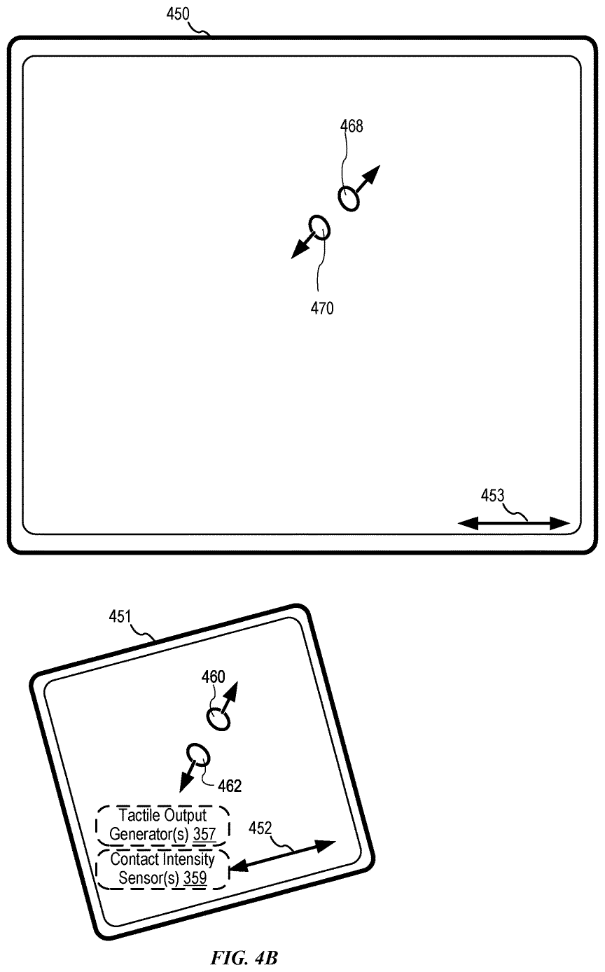

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., touch-sensitive surface 451 in FIG. 4B) has a primary axis (e.g., 452 in FIG. 4B) that corresponds to a primary axis (e.g., 453 in FIG. 4B) on the display (e.g., display 450). In accordance with these embodiments, the device detects contacts (e.g., contact 460 and contact 462 in FIG. 4B) with the touch-sensitive surface 451 at locations that correspond to respective locations on the display (e.g., in FIG. 4B, contact 460 corresponds to 468 and contact 462 corresponds to 470). In this way, user inputs (e.g., contact 460 and contact 462, and movements thereof) detected by the device on the touch-sensitive surface (e.g., touch-sensitive surface 451 in FIG. 4B) are used by the device to manipulate the user interface on the display (e.g., display 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

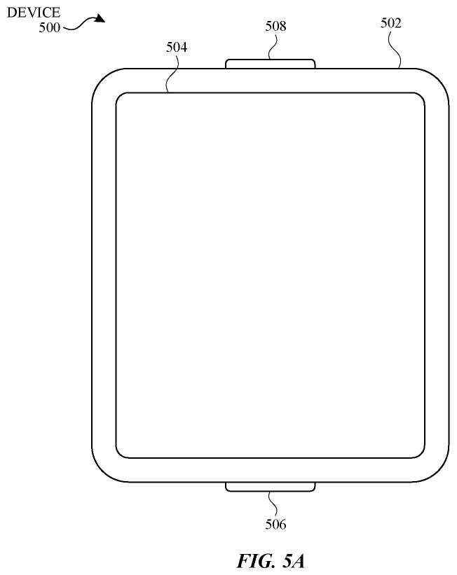

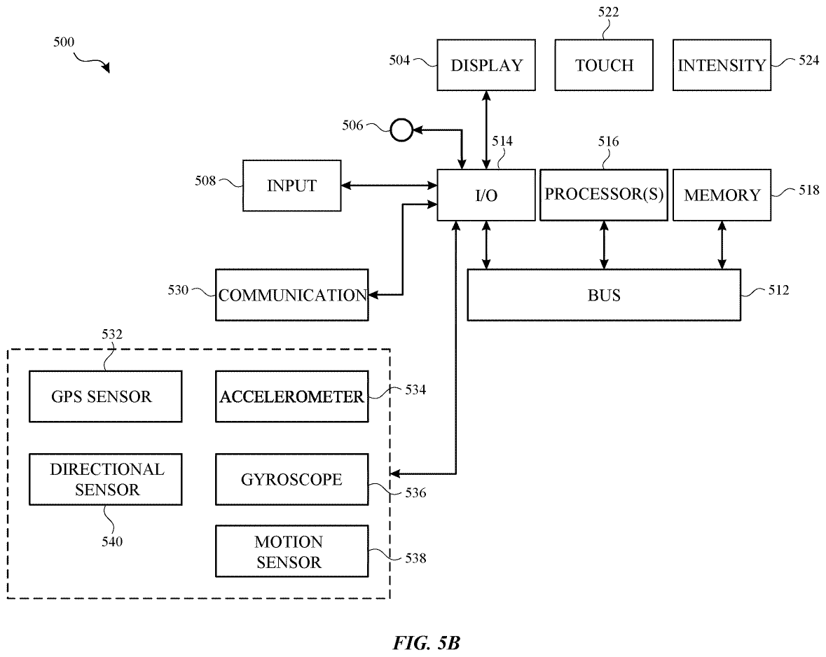

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3A. Device 500 has bus 512 that operatively couples I/O section 514 with one or more computer processors 516 and memory 518. I/O section 514 can be connected to display screen 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage media, for storing computer-executable instructions, which, when executed by one or more computer processors 516, for example, can cause the computer processors to perform the techniques described below, including processes 700 and/or 800 (FIGS. 7 and/or 8). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray® technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3A, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

As described herein, content is automatically generated by one or more computers in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly, a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example, when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Attention is now directed towards embodiments of user interfaces (“UI”) and associated processes that are implemented on an electronic device, such as portable multifunction device 100, device 300, or device 500.

FIGS. 6A-6V illustrate user interfaces for performing visual analysis operations, in accordance with some embodiments. The user interfaces in these figures are used to illustrate the processes described below, including the processes in FIGS. 7 and 8.

FIGS. 6A and 6B illustrate back (e.g., FIG. 6A) and front (e.g., FIG. 6B) views of computer system 600 (e.g., a mobile phone device) including a set of hardware buttons 602; display 604, including a touch-sensitive surface, on the front of the device; and a set of cameras, including first camera 606A, second camera 606B, and third camera 606C on the rear of the device (e.g., facing the environment), and fourth camera 606D on the front of the device (e.g., facing the user). In some embodiments, the set of cameras include different numbers of cameras, different arrangements of cameras, and/or different types of cameras. For example, the different types of cameras optionally include one or more wide-angle lenses, one or more telephoto lenses, and/or one or more macro lenses. For example, the different types of cameras optionally vary in geometry (e.g., physical or equivalent focal lengths, such as 5 mm, 13 mm, 22 mm, 24 mm, 28 mm, 50 mm, 77 mm, 100 mm, and/or 300 mm, or f-stops of f/1.2, f/1.78, f/2.2, f/2.8, f/3.4, and/or f/8.4), resolution (e.g., 8 MP, 12 MP, 24 MP, 48 MP, and/or 72 MP), pixel size (e.g., 100 nm, 0.5 μm, 1.0 μm, 2.44 μm, 5 μm), and/or presence of other hardware features (e.g., dual or quad pixels, dual pixel autofocus capabilities, and/or optical image stabilization capabilities). In some embodiments, computer system 600 includes one or more sensors, such as light sensors, depth sensors (e.g., structural light sensors, time-of-flight sensors (e.g., LIDAR and/or ultrasonic sensors), and/or stereoscopic camera sensors), motion sensors, and/or audio sensors (e.g., microphones). In some embodiments, the methods described herein using computer system 600 are implemented using (e.g., in conjunction with computer system 600) one or more user devices (e.g., mobile phones, tablet computers, laptop computers, and/or wearable electronic devices (e.g., smart watches and/or head-mounted devices)), remote devices (e.g., servers and/or network-connected devices), and/or peripheral devices (e.g., external storage drives, microphones, speakers, and/or hardware input devices). In some embodiments, computer system 600 includes one or more features of devices 100, 300, or 500 (e.g., the set of cameras can include optical sensor 164).

At FIG. 6B, computer system 600 displays user interface 608, which includes camera preview 608A, a live or near-live representation (e.g., camera feed) of at least a portion of a field-of-view of an environment as captured by one or more of cameras 606A, 606B, 606C, and 606D, and capture object 608B, a user interface object that, when selected, initiates a capture operation using one or more of cameras 606A, 606B, 606C, and 606D. For example, in response to an input such as input 610A, computer system 600 pauses camera preview 608A (e.g., while maintaining displaying a freeze frame in camera preview 608A) and/or captures, via one or more of cameras 606A, 606B, 606C, and 606D, a media item (e.g., photo and/or video media) corresponding to the portion of the field-of-view of the environment represented in camera preview 608A. In some embodiments, input 610A and/or one or more of the inputs discussed below includes one or more detected inputs, such as a touch gesture (e.g., a tap, a swipe, or touch-and-hold), an air gesture (e.g., an air tap or air pinch), a selection input (e.g., via a hardware input mechanism such as a hardware buttons 602), and/or a speech input (e.g., via a microphone, audio sensor, and/or audio input device). In some embodiments, a detected input (e.g., an input including an air gesture and/or selection input) is directed to a respective displayed user interface element (e.g., capture object 608B) when the input is detected while the respective displayed user interface element is selected and/or is in focus.

As illustrated in FIG. 6B, user interface 608 is a visual analysis user interface for performing visual analysis operations (e.g., described in further detail below) based on visual content captured using one or more of cameras 606A, 606B, 606C, and 606D and/or based on stored visual content (e.g., stored photos or videos). In other embodiments, user interface 608 is another kind of user interface with a live or near-live camera preview, such as a user interface for a camera application. For example, performing visual analysis operations includes analyzing and/or using the results of analyzing the representation of the portion of the field-of-view of the environment displayed in camera preview 608A (e.g., while live/near-live or paused) using image and/or video processing techniques, such as machine vision and/or other machine learning techniques to identify (e.g., recognize) certain objects, types (e.g., classes) of objects, types of visual information (e.g., text, symbols, and/or patterns), environmental features (e.g., landmarks, buildings, pathways, and/or weather conditions), and/or other information about the visible environment captured by the one or more cameras. In some embodiments, computer system 600 performs the analysis for the visual analysis operations by processing the field-of-view captured by the cameras (e.g., and represented in viewfinder 2004A) locally, for instance, using image and/or video processing services stored and executed on a device used to display user interface 608 (e.g., a mobile phone, tablet, headset, and/or other personal electronic device), and/or by providing portions of the field-of-view captured by the cameras to a remote image and/or video processing service, such as a server-based machine vision service.

As illustrated in FIG. 6B, user interface 608 includes first visual analysis option 608C, corresponding to a first visual analysis operation for interacting with the visual content using natural-language inputs (e.g., using an intelligent automated assistant, chatbot service, and/or machine learning process, such as a generative machine learning process that generates, based on user-provided prompts and analysis the visual content of camera preview 608A, generative text to provide to the user as text and/or speech outputs in a conversational interaction), and second visual analysis option 608D, corresponding to a second visual analysis operation for interacting with the visual content using a visual (e.g., image-based) search process.

In response to an input selecting first visual analysis option 608C, such as input 610B, or selecting second visual analysis option 608D, such as input 610C, computer system 600 initiates performing the corresponding visual analysis operation using a default and/or predetermined service provider for the corresponding visual analysis operation. In some embodiments, the default/predetermined service providers for the visual analysis operations corresponding to first visual analysis option 608C and second visual analysis option 608D are remote (e.g., server-and/or cloud-based) service providers, where information about the visual content is transmitted from computer system 600 to the remote service provider and one or more results of the visual analysis operation are transmitted from the remote service provider back to computer system 600. In some embodiments, in response to an input selecting first visual analysis option 608C (e.g., input 610B) or selecting second visual analysis option 608D (e.g., input 610C), computer system 600 initiates performing the corresponding visual analysis operation based on the overall visual context of camera preview 608A. For instance, computer system 600 provides the service provider with a representation of the whole frame included in camera preview 608A (e.g., the image data and/or results of initial visual analysis of the visual content performed by computer system 600).

While displaying user interface 608, computer system 600 analyzes, using image and/or video processing techniques, the visual content of camera preview 608A to identify candidate features of interest. For example, computer system 600 determines whether a user is likely to request performance of one or more visual analysis operations to obtain additional information about any of the features (e.g., objects and/or information) detected in the portion of the environment represented in camera preview 608A. In some embodiments, computer system 600 determines whether a detected feature is a feature of interest based on the prominence (e.g., size, placement, and/or focus) of the feature within camera preview 608A, based on which actions (e.g., tasks available to be performed by computer system 600) are associated with the feature, based on past user interactions with visual content, and/or based on contextual information (e.g., date, time of day, location, and/or computer system status). At FIG. 6B, computer system 600 does not identify any candidate features of interest in camera preview 608A. For example, although computer system 600 detects features in camera preview 608A, such as a tree, a light post, flying birds, and the side of a building, the features are not prominent within the frame.

As illustrated in FIG. 6B, computer system 600 displays user interface 608 with gesture prompt 612, which includes the instruction, “highlight to search.” For example, computer system 600 displays gesture prompt 612 upon initially displaying user interface 608 (e.g., automatically, at launch of the visual intelligence user interface) and/or in response to detecting that user interface 608 includes visual content (e.g., camera preview 608A) upon which visual analysis operations can be performed. Gesture prompt 612 prompts a user to indicate a region of interest within camera preview 608A by using a gesture to highlight a portion of the visual content, such as described below with respect to FIGS. 6E and 6I. As illustrated in FIG. 6B, gesture prompt 612 is displayed with initial visual characteristics, such as an initial text size, color, opacity, border effect, background effect, and/or animation (e.g., animating gesture prompt 612 shimmering, flashing, and/or moving around).

At FIG. 6C, the representation of the portion of the field-of-view of the environment displayed in camera preview 608A updates (e.g., panning to the right to capture a different portion of the environment), and computer system 600 detects a candidate feature of interest, the restaurant building with the sign reading “Bistro on Third.” For example, computer system 600 determines that the restaurant building is sufficiently prominent within camera preview 608A, close to the center of the frame, in focus, and/or at least a threshold size relative to other features detected in camera preview 608A and/or the size of the frame. For example, computer system 600 determines that restaurant-type features are associated with specific, high-quality (e.g., relevant, helpful, and/or likely) candidate actions available to be performed by computer system 600, such as viewing additional information about the restaurant from a restaurant review application, booking a reservation at the restaurant (e.g., through a website or application), and/or adding the restaurant location to a favorite restaurants list.

At FIG. 6C, when the visual content (e.g., camera preview 608A) has been displayed for less than a threshold period of time (e.g., 0.25 s, 0.5 s, 1 s, 3 s, 5 s, 10 s, 30 s, or 1 min), computer system 600 maintains displaying gesture prompt 612. In some embodiments, computer system 600 maintains displaying gesture prompt 612 at least until a candidate feature of interest is identified in camera preview 608A. As illustrated in FIG. 6C, computer system 600 changes the appearance of gesture prompt 612 over time, gradually shrinking gesture prompt 612. For example, computer system 600 reduces the visual prominence (e.g., reducing the size, opacity, brightness, and/or contrast) or increases the visual prominence of gesture prompt 612 relative to other elements of user interface 608.

At FIG. 6D, the visual content (e.g., camera preview 608A) has been displayed for at least the threshold period of time, and computer system 600 has not detected a highlighting gesture input indicating a region of interest within camera preview 608A. Accordingly, at FIG. 6D, computer system 600 displays feature indication 614, a user interface object corresponding to the restaurant detected in camera preview 608A (e.g., the identified candidate feature of interest). Feature indication 614A includes text labeling the name of the identified restaurant (e.g., “Bistro on Third”) and an icon that corresponds to the identified type of the feature of interest (e.g., a fork and knife icon corresponding to a restaurant-type feature). In some embodiments, as described further below with respect to FIG. 6O, feature indication 614A indicates one or more of the candidate actions associated with the identified feature. For example, the fork and knife icon indicates the available action of viewing more information about the restaurant from a restaurant review application.

As illustrated in the side panel of FIG. 6D, when computer system 600 initially displays feature indication 614A, computer system 600 animates feature indication 614A emerging (e.g., expanding and splitting) from capture object 608B. As illustrated in FIG. 6D, in some embodiments, computer system 600 continues to display gesture prompt 612 along with feature indication 614A. As illustrated in FIG. 6D, after displaying feature indication 614A, computer system 600 continues displaying capture object 608B and, in response to inputs such as input 616C selecting capture object 608B, pauses camera preview 608A (e.g., while maintaining displaying a freeze frame in camera preview 608A) and/or captures, via one or more of cameras 606A, 606B, 606C, and 606D, a media item (e.g., photo and/or video media) corresponding to the portion of the field-of-view of the environment represented in camera preview 608A, as described above with respect to input 610A.

At FIG. 6E, computer system 600 detects one or more inputs requesting additional information about the visual content displayed in camera preview 608A, and, in particular, additional information about the restaurant. For example, computer system 600 detects input 616A, a touch (e.g., tap) input selecting feature indication 614A corresponding to the restaurant. Alternatively, computer system 600 detects input 616B, a gesture input highlighting the restaurant within camera preview 608A, for instance, by touching and scribbling over the region to indicate interest in the restaurant.

As illustrated in the side panel of FIG. 6E, while detecting input 616B, computer system 600 displays highlight effect 618A that overlays camera preview 608A, following the path of input 616B to indicate the region of camera preview 608A that is being selected with the gesture. For example, the size and shape of highlight effect 618A are based on the movement of input 616B, like a blob of ink being deposited and/or spread across camera preview 608A by the touch. In some embodiments, at least some portions of highlight effect 618A are semi-transparent and/or displayed with one or more colors (e.g., represented in FIG. 6E by different fill patterns) selected based on the region of camera preview 608A underlying the path of the gesture, such that highlight effect 618A appears to at least partially blend with the visual content being highlighted. In some embodiments, at least some portions of highlight effect 618A are animated with changing colors. For example, portions of highlight effect 618A are initially displayed with one color, then change to one or more other colors over time, creating a color cycling effect through highlight effect 618A as it grows. In some embodiments, at least some portions of highlight effect 618A are displayed with a high dynamic range (HDR)/extended dynamic range (EDR) effect, where computer system 600 displays portions of highlight effect 618A with a greater maximum brightness than the maximum brightness used to display other content in user interface 608 so the portions of highlight effect 618A appear to glow brightly in contrast to the underlying visual content.

At FIG. 6F, in response to detecting the one or more inputs requesting additional information about the restaurant (e.g., input 616A or input 616B), computer system 600 displays highlight effect 618B semi-transparently overlaying the portion of camera preview 608A representing the restaurant. For example, highlight effect 618B is displayed in response to input 616A, highlighting the portion of the visual content corresponding to the identified feature of interest, or in response to input 616B, highlighting the portion of visual content corresponding to the region of interest indicated by the gesture. In some embodiments, when highlighting the portion of visual content corresponding to the region of interest indicated by input 616B, computer system 600 adjusts the form of highlight effect 618B based on detected edges of one or more features (e.g., the feature of interest corresponding to feature indication 614A and/or detected feature(s) scribbled over by the gesture), such that the edges of highlight effect 618B approximately align with the edges of the feature(s). In some embodiments, computer system 600 displays highlight effect 618B with similar and/or related visual characteristics to highlight effect 618A, such as displaying highlight effect 618B with a similar HDR/EDR effect and/or animated fill and edge effects that shimmer in similar colors to the color cycling effect of highlight effect 618A. In some embodiments, in response to detecting input 616B (e.g., the gesture highlighting the restaurant), computer system 600 additionally displays feature symbol 618C, a tag with a fork and knife icon, representing a type of the feature detected in the highlighted area.

At FIG. 6F, in response to detecting the one or more inputs requesting additional information about the restaurant (e.g., input 616A or input 616B), computer system 600 displays visual analysis user interface 620, a partial-screen user interface that overlays the lower portion of user interface 608 and camera preview 608A. As illustrated in FIG. 6F, visual analysis user interface 620 includes additional information and options related to the restaurant detected in the visual content, including additional information 622 and action options 624. For example, additional information 622 is displayed in response to input 616A selecting feature indication 614A and includes information about the identified restaurant retrieved from the restaurant review application (e.g., the results of performing the available action indicated by feature indication 614A). Action options 624 are user interface objects corresponding to actions available to be performed based on the restaurant detected in camera preview 608A (e.g., the feature of interest selected by input 616A or input 616B), including (from left to right) an option for creating a reminder, sending a message, adding to a favorite location list, making a reservation, and sending an email. For example, action options 624 are represented in result visual analysis user interface 620 by icons for the applications used to perform the corresponding actions.

In response to detecting a selection of an action option from action options 624, computer system 600 causes the corresponding application to perform the action based on the detected restaurant, including providing the corresponding application with a representation of the detected restaurant. For example, in response to detecting input 630 at FIG. 6F, selecting the action item for sending a message, computer system 600 provides a messaging application with a representation of the restaurant and causes a messaging application to initiate a process for sending a message including the representation of the restaurant. For example, the representation of the restaurant to be sent includes image content corresponding to the restaurant (e.g., at least portion of the visual content from camera preview 608A), text corresponding to the restaurant (e.g., the restaurant's name), contextual information corresponding to the restaurant (e.g., a detected location at which the visual content was captured), and/or retrieved information corresponding to the restaurant (e.g., information from the restaurant review application).

As illustrated in FIG. 6F, visual analysis user interface 620 includes controls for the first visual analysis operation for interacting with the visual content using natural-language inputs. The controls for the first visual analysis operation include natural-language input field 626A for accepting natural-language (e.g., textual and/or audio) prompts from a user and first service provider control 626B for selecting a service provider from a plurality of service providers for performing the first visual analysis operation, such as different intelligent automated assistant (e.g., digital assistant) services, chatbot services, and/or machine learning services. As illustrated in FIG. 6F, first service provider control 626B indicates the currently selected service provider, labeled “Chat.” For example, the Chat service provider is a remote large-language model (LLM) service that generates a response to a user-provided prompt based on the prompt and visual context information provided by computer system 600. In some embodiments, when performing the first visual analysis operation via visual analysis user interface 620, computer system 600 provides the currently selected service provider with a representation of only the visual content corresponding to the restaurant (e.g., the portion indicated by highlight effect 618B). For example, in contrast to performing the first visual analysis operation in response to a selection (e.g., input 610B) of first visual analysis option 608C, where a representation the whole frame of camera preview 608A is analyzed, performing the first visual analysis operation via visual analysis user interface 620 limits analysis to the portion of camera preview 608A selected by input 616A or input 616B. Additional description and examples of selecting the service provider for the first visual analysis operation and performing first visual analysis operation are provided below with respect to FIGS. 6M-6N and 6T-6V.

As illustrated in FIG. 6F, visual analysis user interface 620 includes controls for the second visual analysis operation for interacting with the visual content using a visual (e.g., image-based) search process. The controls for the second visual analysis operation include second service provider control 628A for selecting a service provider from a plurality of service providers for performing the second visual analysis operation, such as different search engines, applications, and/or databases. As illustrated in FIG. 6F, second service provider control 628A includes a platter of options, including an option for a service provider labeled “Search 1” and an option for a service provider labeled “Search 2,” and indicates that the Search 1 service provider is currently selected by displaying the corresponding option with border and/or background elements in the platter. For example, the Search 1 service provider is a remote visual search engine that searches indexed Internet content for visual content (e.g., images, graphics, and/or video) that is similar to and/or matches visual content provided by computer system 600. In some embodiments, the Search 1 service provider is a default service provider for the second visual analysis operation. As discussed with respect to the first visual analysis operation, in some embodiments, when performing the second visual analysis operation via visual analysis user interface 620, computer system 600 provides the currently selected service provider with a representation of only the visual content corresponding to the restaurant (e.g., the portion indicated by highlight effect 618B) to search. Additional description and examples of selecting the service provider for the second visual analysis operation and performing second visual analysis operation are provided below with respect to FIGS. 6K-6M and 6R-6U.

At FIG. 6G, computer system 600 displays user interface 632, a user interface for a web browser application that is currently playing a video (e.g., labeled “Cooking Show” embedded on a webpage (e.g., “foodvideos.com”) displayed in a URL bar at the bottom of user interface 632). While displaying user interface 632 with the content illustrated in FIG. 6G, computer system 600 detects a request to capture a screenshot, such as input 634, an input including button presses on two of the set of hardware buttons 602 at overlapping times (e.g., simultaneously and/or near-simultaneously).

In response to detecting input 634, at FIG. 6H, computer system 600 displays screenshot user interface 636 including screenshot 636A, an image representation of the visual content displayed via display 604 when input 634 was detected (e.g., the URL bar, webpage, and a still capture of the embedded video). Additionally, screenshot user interface 636 includes first visual analysis option 636C and second visual analysis option 636D. For example, first visual analysis option 636C, corresponding to the first visual analysis operation for interacting with the visual content using natural-language inputs, and second visual analysis option 636D, corresponding to the second visual analysis operation for interacting with the visual content using a visual (e.g., image-based) search process. For example, selecting first visual analysis option 636C or second visual analysis option 636D initiates performance of the corresponding visual analysis operation as described with respect to first visual analysis option 608C and second visual analysis option 608D in FIG. 6B. For instance, computer system 600 performs the corresponding operation using a default and/or predetermined service provider and/or based on the visual context of screenshot 636A as a whole. As illustrated in FIG. 6H, screenshot user interface 636 further includes finalize option 636B (e.g., a user interface object that, when selected, initiates a process for storing screenshot 636A, for instance, as a media item and/or an item on a copy/paste clipboard), markup option 636E (e.g., a user interface object that, when selected, initiates a process for marking up screenshot 636A, as described below with respect to FIG. 6P), and delete option 636F (e.g., a user interface object that, when selected, discards screenshot 636A).

As illustrated in FIG. 6H, computer system 600 displays screenshot user interface 636 with gesture prompt 638, including the instruction, “highlight to search.” Similarly to gesture prompt 612, gesture prompt 638 prompts a user to indicate a region of interest within screenshot 636A by using a gesture to highlight a portion of the visual content. At FIG. 6H, screenshot 636A has been displayed for less than a threshold period of time (e.g., 0.25 s, 0.5 s, 1 s, 3 s, 5 s, 10 s, 30 s, or 1 min), so computer system 600 does not initially display screenshot user interface 636 with feature indications for candidate features of interest detected by analyzing the visual content of 636A. For example, even if one or more candidate features of interest have already been identified within screenshot 636A, such as the plant, peppers, ginger, and garlic visible in the frame of the embedded video, the text of the video title, and/or the text of the webpage URL, computer system 600 refrains from automatically providing indications of those features for at least the threshold period of time after screenshot 636A was taken.

At FIG. 6I, computer system 600 detects input 640, a gesture input drawing a path around a region of interest within screenshot 636A. In some embodiments, while detecting input 640, computer system 600 displays a highlight effect that overlays screenshot 636A and follows the path of input 640, such as described above with respect to FIG. 6E and highlight effect 618A. At FIG. 6J, in response to detecting input 640, computer system 600 displays highlight effect 642 semi-transparently overlaying the portion of screenshot 636A indicated by input 640 (e.g., the region of interest), for example, similar to highlight effect 618B described with respect to FIG. 6F. As illustrated in FIG. 6J, the form of highlight effect 642 is based on the path drawn by input 640, filling in the region of screenshot 636A encircled by the highlighting motion (e.g., without adjusting based on detected edges of the plant visible in the highlighted region).

At FIG. 6J, screenshot 636A has been displayed for at least the threshold period of time; however, because computer system 600 began detecting input 640, a gesture input indicating a region of interest in screenshot 636A, before the threshold period of time had elapsed, computer system 600 continues to refrain from automatically providing indications of identified candidate features of interest because input 640 was detected before the threshold period of time had elapsed.

At FIG. 6K, in response to detecting input 640, computer system 600 displays visual analysis user interface 620 partially overlying screenshot user interface 636. As illustrated in FIG. 6K, computer system 600 populates visual analysis user interface 620 with information and options specifically based on the visual content included in the indicated region of interest in screenshot 636A (e.g., the region selected by input 640 and overlaid by highlight effect 642). In particular, at FIG. 6K, computer system 600 presents second service provider control 628A with a third service provider option, labeled “Plant App.” For example, the plant application includes specialized visual search functionality for performing an image-based search for plant-related content (e.g., using a specialized search database of plant images and/or visual analysis systems specially trained on plant data). Additionally, computer system 600 presents action options 624 for the indicated region of interest that include partially different options than presented in visual analysis user interface 620 for the restaurant at FIG. 6F, including options for the actions of providing information about the plant to a plant application (e.g., in response to input 644A) and adding a representation of the highlighted portion of screenshot 636A to a notes application (e.g., in response to input 644B), and omitting the options for adding to a favorite location list and making a reservation.

In some embodiments, computer system 600 orders action options 624 and/or the options of second service provider control 628A based on the features of interest detected within the indicated region of interest (e.g., the detected plant), prioritizing action options and service provider options that the user has used to interact with similar features of interest in the past and/or that are particularly relevant to the type of the detected features. For example, at FIG. 6K, computer system 600 orders the option for the Search 1 service provider first (e.g., and/or preselects the Search 1 service provider) based on past user interactions where the user performed image-based searches on visual content of plants using the Search 1 service provider.

As illustrated in FIG. 6K, visual analysis user interface 620 further includes placeholders 628B, user interface elements standing in for the image-based search results of performing the second visual analysis operation that are displayed below second service provider control 628A. For example, computer system 600 does not automatically perform the second visual analysis operation in response to detecting input 640 indicating the region of interest within screenshot 636A. Accordingly, rather than displaying thumbnails of actual images returned via an image-based search operation, computer system 600 displays grayed-out, blurry, and/or solid-color thumbnail stand-ins approximating where and how the results of a performance of the second visual analysis operation would be displayed within visual analysis user interface 620. As illustrated in FIG. 6K, placeholders 628B appear to extend off the bottom of display 604, indicating that scrolling down in visual analysis user interface 620 would reveal additional content.

At FIG. 6K, computer system 600 detects input 644C, an input selecting the option for the Plant App service provider from second service provider control 628A. At FIG. 6L, in response to detecting input 644C, computer system 600 changes the currently-selected service provider for performing the second visual analysis operation to the Plant App service provider, updating the appearance of second service provider control 628A to indicate the changed selection (e.g., displaying the Plant App option with the border and/or background elements previously displayed with the Search 1 option in the platter of second service provider control 628A).

At FIG. 6L, after changing the currently selected service provider for performing the second visual analysis operation, computer system 600 detects input 646, an upwards swipe input across visual analysis user interface 620. For example, input 646 is an input scrolling down through the contents of visual analysis user interface 620 and/or pulling the frame of visual analysis user interface 620 further up to reveal additional content, as indicated by placeholders 628B extending off the bottom of display 604.

At FIG. 6M, in response to detecting input 646, computer system 600 causes performance of the second visual analysis operation, using the Plant App service provider to perform a visual search based on the indicated region of interest within screenshot 636A, and displays result items 628C, representing the results of the performance, within visual analysis user interface 620. For example, result items 628C include images, text, links, and/or user interface elements returned by the Plant App service provider, such as images of plants that are visually similar to the plant highlighted by the user, a user interface element identifying the type (e.g., species and/or varietal) of the plant highlighted by the user (e.g., “Thai basil”), and links to articles (e.g., in the plant application) relevant to the plant highlighted by the user. Because computer system 600 had detected input 640 indicating the region of interest within screenshot 636A, computer system 600 does not provide other portions of screenshot 636A to the Plant App service provider to use in the performance of the second visual analysis operation, and the results of the visual search performed using the Plant App service provider do not include results based on the peppers, ginger, and garlic visible in screenshot 636A outside the region indicated by highlight effect 642. As illustrated in FIG. 6M, in response to detecting input 646 swiping up across visual analysis user interface 620, computer system 600 displays visual analysis user interface 620 fully overlaying screenshot user interface 636, extending the area available for result items 628C.

Alternatively, in some embodiments, computer system 600 causes performance of the second visual analysis operation using the Plant App service provider and displays result items 628C as illustrated in FIG. 6 Min response to input 644C selecting the Plant App service provider option from second service provider control 628A, without requiring an additional input such as 646. In some embodiments, displaying the result items includes displaying visual analysis user interface 620 in the full-overlay view. For example, changing the currently selected service provider for one of the visual analysis operations via visual analysis user interface 620 also triggers performance of the visual analysis operation using the newly selected service provider. In some embodiments, in response to detecting an input requesting to change the service provider for the second visual analysis operation while result items 628C are displayed, computer system 600 automatically causes performance of the second visual analysis operation using the changed service provider and replaces result items 628C with result items from the newly performed search.

At FIG. 6M, computer system 600 detects input 648, an input directed to natural-language input field 626A for the first visual analysis operation, while first service provider control 626B indicates that the currently selected service provider is the Chat service provider. In response to detecting input 648, at FIG. 6N, computer system 600 displays user interface 650, a chat user interface for interacting with the Chat service provider. As illustrated in FIG. 6N, user interface 650 includes prompt entry user interface 650A, a natural-language input field displayed with a virtual keyboard. As illustrated in FIG. 6N, user interface 650 partially overlays the screenshot user interface 636, so a portion of screenshot 636A and highlight effect 642 remain visible while interacting with the Chat service provider, indicating that the interaction is analyzing the highlighted portion of screenshot 636A as visual context.

In response to receiving a prompt via prompt entry user interface 650A, such as a natural-language prompt “What is this?” typed via the virtual keyboard and/or spoken by the user (e.g., after computer system 600 detects input 648 and/or displays user interface 650), computer system 600 displays the prompt in conversation element 650B and provides the prompt to the Chat service provider to cause the performance of the first visual analysis operation, using the Chat service provider to generate a response based on the prompt and the visual context of the indicated region of interest of screenshot 636A. As illustrated in FIG. 6N, computer system 600 displays the response generated by the Chat service provider, the text, “This looks like a basil plant (Ocimum basilicum),” in conversation element 650C. Because computer system 600 had detected input 640 indicating the region of interest within screenshot 636A, computer system 600 does not provide other portions of screenshot 636A to the Chat service provider to use in the performance of the first visual analysis operation, so the response is not generated based on the peppers, ginger, and garlic visible in screenshot 636A outside the region indicated by highlight effect 642. While displaying user interface 650, in response to receiving additional natural-language prompts via prompt entry user interface 650A, such as the prompt “How often should I water?” illustrated in FIG. 6N, computer system 600 provides the additional prompts to the Chat service provider to generate responses based on the indicated region of interest within screenshot 636A, allowing the user to have a conversational, back-and-forth interaction about the feature indicated by highlight effect 642.

At FIG. 6N, computer system 600 detects input 652 directed to screenshot 636A and/or a portion of display 604 outside of user interface 650. In some embodiments, in response to input 652, computer system 600 stops displaying user interface 650, returning to screenshot user interface 636 as illustrated in FIG. 6H, and further stops displaying highlight effect 642. In some embodiments, in response to input 652, computer system 600 stops displaying user interface 650 and re-displays visual analysis user interface 620 and highlight effect 642 as described in FIG. 6L.

At FIG. 6O, computer system 600 displays screenshot user interface 636, including screenshot 636A and screenshot control options 636B-636F. At FIG. 6O, screenshot 636A has been displayed for at least a threshold period of time (e.g., 0.25 s, 0.5 s, 1 s, 3 s, 5 s, 10 s, 30 s, or 1 min) without computer system 600 detecting a gesture input indicating a region of interest within screenshot 636A—for example, if input 640 had not been received at FIG. 6I, or if visual analysis user interface 620 and/or user interface 650 were dismissed and no gestures indicating additional regions of interest were detected. Accordingly, at FIG. 6O, computer system 600 displays a set of feature indications corresponding to candidate features of interest detected in screenshot 636A. In particular, feature indication 654A corresponds to the plant detected in screenshot 636A and includes a plant icon corresponding to the identified type of the feature, and the text “Set reminder,” corresponding to the available action of setting up a reminder based on the detected plant (e.g., a reminder to the user to buy a basil plant at the store or to water the user's plants). Feature indication 654B corresponds to the peppers, garlic, and ginger detected in screenshot 636A and includes a grocery bag icon for a grocery delivery application, indicating an available action of ordering groceries using the grocery delivery application. However, feature indication 654B is only partially displayed at FIG. 6O (e.g., cutting off the included text, “Order groceries”), appearing to extend out of screenshot user interface to the right, indicating that additional feature indications are available by scrolling left (e.g., as described with respect to FIG. 6Q).

At FIG. 6O, computer system 600 detects input 656 directed to markup option 636E. In response to detecting input 656, at FIG. 6P, computer system 600 updates screenshot user interface 636, replacing first visual analysis option 636C, second visual analysis option 636D, feature indication 654A, and feature indication 654B with markup options 636G at the bottom of screenshot user interface 636. For example, markup options 636G include options for selecting different markup tools (e.g., options for marking up screenshot user interface 636A using marks resembling pencil, highlighter, pen, and/or marker marks, for erasing markup, and/or for displaying a digital ruler), selecting different colors for markup, and providing additional markup actions. For example, in response to detecting input 657A, computer system 600 displays a menu for markup actions such as adding text to the image, adding overlaying image elements (e.g., drawing shapes or applying stickers), and/or adding a metadata caption (e.g., alt text).

Additionally, as illustrated in FIG. 6P, computer system 600 updates screenshot user interface 636 to replace markup option 636E with visual analysis option 636H. In response to detecting input 657B directed to visual analysis option 636H, computer system 600 again updates screenshot user interface 636, replacing markup options 636G with first visual analysis option 636C, second visual analysis option 636D, feature indication 654A, and feature indication 654B and replacing visual analysis option 636H with markup option 636E as illustrated in FIG. 6Q.

At FIG. 6Q, computer system 600 detects input 658, swiping right to left across feature indication 654A and feature indication 654B. In response to detecting input 658, computer system 600 scrolls the set of feature indications to the left, displaying feature indication 654B (e.g., partially) and feature indication 654C as illustrated in FIG. 6R. Feature indication 654C corresponds to the peppers, garlic, and ginger detected in screenshot 636A and includes a sizzling pan icon and the text “Ingredients,” corresponding to the type of the detected feature and indicating that additional visual analysis information is available for the detected ingredients. At FIG. 6Q, computer system 600 detects input 660 directed to feature indication 654C.

At FIG. 6S, in response to detecting input 660, computer system 600 displays highlight effect 662A overlaying the peppers in screenshot 636A, highlight effect 662B overlaying the garlic in screenshot 636A, and highlight effect 662C overlaying the ginger in screenshot 636A, indicating each of the features of interest corresponding to feature indication 654C. Additionally, computer system 600 displays visual analysis user interface 620 as illustrated in FIG. 6S, populated with information and options based on the peppers, garlic, and ginger detected in screenshot 636A (e.g., the candidate features of interest corresponding to feature indication 654C). As illustrated in FIG. 6S, computer system 600 displays visual analysis user interface 620 with action option 664A, action option 664B, and action option 664C, each corresponding to the action of adding a representation of one of the candidate features of interest (e.g., text identifying the detected ingredient) to a grocery list (e.g., in a notes application, reminders application, and/or grocery delivery application). For example, action option 664A, action option 664B, and action option 664C are independently selectable, allowing the user to add one, two, or all three ingredients to the grocery list.

As illustrated in FIG. 6S, in response to detecting input 660, computer system 600 displays second service provider control 628A with a third service provider option, labeled “Cooking App.” For example, the Cooking App service provider is a cooking application that provides a specialized visual search functionality for performing an image-based search for food-related content (e.g., using a specialized search database of recipes and/or visual analysis systems specially trained on food and cooking data). As indicated by the border and/or background elements in the platter of second service provider control 628A, in response to detecting input 660, computer system 600 automatically selects the Cooking App service provider as the currently selected service provider. For example, computer system 600 determines that the selection of the peppers, garlic, and ginger as the features of interest to be analyzed using visual analysis user interface 620 indicates a high probability that the Cooking App service provider will be used, for instance, based on the type of the features and/or past user interactions using the Cooking App service provider to perform visual searches based on images of groups of ingredients.

At FIG. 6S, rather than displaying visual analysis user interface 620 with placeholders 628B (e.g., as described with respect to FIG. 6K), computer system 600 automatically causes performance of the second visual analysis operation based on the selected candidate features of interest in screenshot 636A (e.g., the visual content corresponding to the peppers, garlic, and ginger) and using the Cooking App service provider (e.g., the automatically-selected service provider). For example, computer system 600 automatically causes performance of the second visual analysis operation in response to input 660 based on a determination that the type of the candidate features of interest and/or past user interactions indicate that a visual search is likely to be used to obtain additional information about the group of ingredients.

As illustrated in FIG. 6S, computer system 600 automatically displays visual analysis user interface 620 with result items 628D, representing the results of the visual search performed by the Cooking App service provider. For example, result items 628D include images, text, links, and/or user interface elements corresponding to recipe results returned by the Cooking App service provider based on the ingredients peppers, garlic, and ginger. For example, in response to detecting input 666A directed to a result item including the text “spicy stir-fry” and a thumbnail image of a dish, computer system 600 opens the cooking application to a corresponding recipe user interface for the spicy stir fry dish (e.g., the Cooking App service provider returns a result item including an application deep link to a corresponding recipe). As illustrated in FIG. 6S, visual analysis user interface 620 is displayed in the partial-overlay view in response to detecting input 660, so result items 628D appear to extend off the bottom of display 604, indicating that additional results of the search performed by the Cooking App service provider are accessible by scrolling down through the contents of visual analysis user interface 620 and/or pulling the frame of visual analysis user interface 620 further up.

At FIG. 6S, computer system 600 detects input 666B directed to the option for the Search 1 service provider in second service provider control 628A and, in response, changes the currently selected service provider for performing the second visual analysis operation to the Search 1 service provider. In some embodiments, because result items 628D from performing the visual search using the Cooking App service provider are displayed when input 666B is detected, computer system 600 automatically causes performance of the second visual analysis operation using the Search 1 service provider after changing the selection. In some embodiments, computer system 600 causes performance of the second visual analysis operation using the Search 1 service provider in response to detecting input 666C, a swipe up across visual analysis user interface 620, after changing the service provider selection (e.g., as described with respect to FIGS. 6L-6M).

As illustrated in FIG. 6T, after performing the second visual analysis operation using the Search 1 service provider (e.g., in response to input 666B and/or input 666C), computer system 600 displays visual analysis user interface 620 with result items 628E, representing the results of the visual search performed by the Search 1 service provider. For example, result items 628E include images, text, links, and/or user interface elements corresponding to web search results returned by the Search 1 service provider based on the visual content of the peppers, garlic, and ginger.

At FIG. 6T, computer system 600 detects input 668 directed to first service provider control 626B and, in response, displays an expanded view of first service provider control 626B (e.g., a pull-down menu), providing multiple service provider options for the first visual analysis operation, including the previously selected Chat service provider and a service provider labeled “Assistant.” For example, the Assistant service provider is an intelligent automated assistant system for assisting with control of computer system 600 using local and/or remote intelligence processes to interpret and operationalize (e.g., perform actions based on/in response to) natural-language (e.g., speech and/or text) user inputs. At FIG. 6U, in response to detecting a selection of the Assistant service provider option via first service provider control 626B (for instance, by dragging input 668 down while displaying the pull-down menu), computer system 600 changes the currently selected service provider for performing the first visual analysis operation to the Assistant service provider, returning first service provider control 626B to the original (e.g., un-expanded) view and displaying first service provider control 626B with the “Assistant” label.

As illustrated in FIG. 6U, computer system 600 detects input 670, an input directed to natural-language input field 626A for the first visual analysis operation, while the Assistant service provider is the currently selected service provider for the first visual analysis operation. In response to detecting input 670, at FIG. 6V, computer system 600 displays user interface 672, a chat user interface for interacting with the Assistant service provider. As illustrated in FIG. 6N, user interface 672 includes prompt entry user interface 672A, a natural-language input field for providing textual inputs to the intelligent automated assistant; additionally, while displaying user interface 672, computer system 600 accepts speech inputs to the intelligent automated assistant (e.g., without requiring the user to provide a specific trigger phrase or to select a specific dictation option). As illustrated in FIG. 6U, user interface 672 partially overlays the screenshot user interface 636, so a portion of screenshot 636A and highlight effect 662A, highlight effect 662B, and highlight effect 662C remain visible while interacting with the Assistant service provider, indicating that the interaction is analyzing the highlighted portion of screenshot 636A as visual context.

As illustrated in FIG. 6V, computer system 600 detects input 674, a speech input, “Tell Joe to pick these up at the store.” In response to detecting input 674, computer system 600 provides the Assistant service provider with the prompt (e.g., the audio of input 674, a transcription thereof, and/or a tokenized representation of input 674) to cause the Assistant service provider to perform the first visual analysis operation based on input 674 and the visual context of the highlighted features of interest in screenshot 636A. As illustrated in FIG. 6V, computer system 600 displays response 672B provided by the Assistant service provider, a response user interface including a draft text message, “Pick up peppers, garlic, and ginger from the store” and an indication of a selected contact, Joe, along with the natural-language response, “Is this okay, or would you like to change it?” Additionally, computer system 600 displays response 672B with user interface object 672C for cancelling (e.g., selecting not to send) the draft message and user interface object 672D for accepting and sending the draft message. Because computer system 600 had detected input 660 selecting feature indication 654C, which corresponded to the peppers, garlic, and ginger detected in screenshot 636A, computer system 600 does not provide other portions of screenshot 636A to the Assistant service provider to use in the performance of the first visual analysis operation, so the draft text message is not generated based on the plant and/or other content visible in screenshot 636A outside the region indicated by highlight effects 662A, 662B, and 662C. As described with respect to user interface 650 in FIG. 6N, while displaying user interface 672 as illustrated in FIG. 6V, providing additional natural-language inputs will prompt additional responses from the Assistant service based on the selected features of interest.

In some embodiments, the user interfaces illustrated in FIGS. 6A-6V with respect to the visual content of camera preview 608A and screenshot 636A are also used for performing visual analysis operations using other types and/or sources of visual content, such as photo and/or video media displayed in a media library, media viewing, and/or media editing user interface. For example, while displaying a photo media item in a photo viewing and/or editing user interface, computer system 600 provides a gesture prompt (e.g., as described with respect to gesture prompts 612 and/or 638), feature indications (e.g., as described with respect to feature indications 614A, 654A, 654B, and/or 654C), and/or visual analysis user interface 620 to allow a user to select specific visual content in the photo media item to analyze and to control the processes and services used for visual analysis of the selected visual content.

FIG. 7 is a flow diagram illustrating a method for providing multiple options for performing visual analysis operations on particular visual content using a computer system, in accordance with some embodiments. Method 700 is performed at a computer system (e.g., 100, 300, 500, and/or 600) (e.g., including one or more mobile phones, personal computers, laptops, tablets, headsets, wearable devices, and/or other electronic devices) that is in communication with one or more display generation components (e.g., display controllers; touch-sensitive display systems; displays (e.g., integrated and/or connected), 3D displays, transparent displays, projectors, and/or heads-up displays) and one or more input devices (e.g., touch-sensitive surfaces, hardware input devices (e.g., a hardware button, switch, dial, stylus, keyboard, and/or mouse), cameras, microphones, gesture input devices, air gesture input devices, and/or gaze input devices). In some embodiments, the computer system is optionally in communication with one or more sensors, such as optical sensors, depth sensors, capacitive sensors, intensity sensors, motion sensors, vibration sensors, audio sensors, light sensors, temperature sensors, and/or biometric sensors. In some embodiments, the computer system is optionally in communication with one or more output devices, such as audio output devices (e.g., speakers and/or headphones) and/or tactile (e.g., haptic) output devices. Some operations in method 700 are, optionally, combined, the orders of some operations are, optionally, changed, and some operations are, optionally, omitted.

As described below, method 700 provides an intuitive way providing multiple options for performing visual analysis operations on particular visual content using a computer system. The method reduces the cognitive burden on a user for selecting visual content to be analyzed, thereby creating a more efficient human-machine interface. For battery-operated computing devices, enabling a user to perform visual analysis operations faster and more efficiently conserves power and increases the time between battery charges.

While displaying (702), via the one or more display generation components, visual content (e.g., 608A and/or 636A) (e.g., a screenshot, photo media item, video media item, displayed application content, and/or a live or near-live camera preview that includes a representation of a field-of-view of one or more cameras in communication with the computer system), wherein at least one visual analysis operation (e.g., an image-based and/or video-based processing operation, such as an operation implementing machine vision, machine learning, and/or generative techniques that are performed by the computer system and/or a remote computer system based on visual information) is available to be performed on the visual content, the computer system displays, via the one or more display generation components, a prompt (e.g., 612 and/or 638) (e.g., including text, images, icons, and/or animations) to use a gesture input (e.g., 616B and/or 640) (e.g., a touch, stylus, and/or air gesture input and/or sequence of inputs) to indicate a region of interest within the visual content (e.g., as illustrated in FIGS. 6B-6E and/or 6H-6J). In some embodiments, the computer system automatically performs at least a first available visual analysis operation on the visual content. For example, the computer system automatically causes the visual content to be analyzed to detect candidate features of interest. In some embodiments, the computer system does not automatically perform at least a second available visual analysis operation on the visual content (e.g., the computer system automatically detects features of interest in the visual content but does not automatically perform a visual search based on the detected visual content). In some embodiments, at least one visual analysis operation is available to be performed while displaying visual content in a respective user interface, such as a camera user interface, a screenshot user interface, a visual analysis user interface, a digital assistant user interface, and/or an application user interface. In some embodiments, at least one visual analysis operation is available to be performed in response to detecting, via the one or more input devices, a user request for visual analysis functionality (in some embodiments, while displaying the visual content). In some embodiments, the prompt indicates a type of gesture input to indicate the region of interest and/or at least one visual analysis operation that will be performed in response to the gesture input based on the indicated region of interest.

While displaying (702), via the one or more display generation components, the visual content (e.g., 608A and/or 636A), in accordance with a determination that a respective set of criteria is satisfied, the computer system displays (706), via the one or more display generation components, an indication (e.g., 614A, 654A, 654B, and/or 654C) of one or more features detected (e.g., automatically detected; in some embodiments, by performing the at least one visual analysis operation on the visual content) within the visual content. In some embodiments, in accordance with a determination that the respective set of criteria is not satisfied, the computer system foregoes displaying the indication of the one or more features. In some embodiments, the indication of the one or more features detected within the visual content includes information indicating one or more types of the detected features (e.g., text labels and/or symbolic representations), one or more candidate actions associated with the detected features, and/or one or more search results associated with the detected features. In some embodiments, the indication of the one or more features includes one or more interactive user interface elements that, when selected, cause performance of one or more follow-up actions based on the detected features.

The respective set of criteria includes a first criterion that is satisfied when a respective gesture input (e.g., 616B and/or 640) indicating a respective region of interest within the visual content has not been detected via the one or more input devices for at least a threshold amount of time (e.g., 0.25 s, 0.5 s, 1 s, 3 s, 5 s, 10 s, 30 s, or 1 min) since the visual content was displayed (e.g., as described with respect to FIGS. 6D and/or 6O) (e.g., a threshold period of time since the user interface for displaying live visual content was displayed and/or a threshold period of time since a particular visual content element was displayed) (e.g., the user has not provided an input indicating a region of interest within the displayed visual content), and the respective set of criteria includes a requirement that the first criterion is satisfied in order for the respective set of criteria to be satisfied (e.g., the first criterion is a necessary criterion of the respective set of criteria). In some embodiments, the first criterion is satisfied when the respective gesture input has not been detected within a predetermined period of time (e.g., a period of time starting from when the visual content is first displayed or from when the prompt was displayed). In some embodiments, in accordance with a determination that the first criterion is not satisfied (e.g., if the computer system detects, via the one or more input devices, a respective gesture input indicating a respective region of interest within the visual content), the computer system displays, via the one or more display generation components, a user interface with results of and/or options for performing one or more visual analysis operations (e.g., as described with respect to FIGS. 6F, 6K-6L, and 8) based on the respective region of interest within the visual content (e.g., the portion of the visual content indicated by the detected gesture input). While displaying visual content for which at least one visual analysis operation is available, providing a prompt guiding a user to us a gesture specify a portion of visual content and conditionally providing an indication of detected features if a gesture is not detected within a period of time performs an operation when a set of conditions has been met (e.g., when the particular feature is detected in the physical environment) without requiring further user input, provides improved visual feedback to the user, and provides improved control of computer system functionality without cluttering the user interface with additional displayed controls, which reduces the power usage and improves the battery life of the computer system by enabling the user to use the device more quickly and efficiently. For example, the prompt indicates to the user that the visual analysis operation is available for the content and how to specify a portion of the visual content to analyze using a gesture, without initially displaying indications of detected content, which could distract the user from the gesture instructions and clutter the display, while automatically displaying the indications of detected content after a period elapses without detecting the gesture guides the user to additional options for interacting with the content other than using the gesture.

In some embodiments, the respective set of criteria includes a second criterion that is satisfied in accordance with a determination that a relevance value (e.g., a metric, score, ranking, and/or heuristic representing the relevance of the feature(s) to the user and/or the current context) associated with the one or more features detected (e.g., automatically detected; in some embodiments, by performing the at least one visual analysis operation on the visual content) within the visual content exceeds a relevance value threshold (e.g., as described with respect to FIGS. 6D and/or 6O) (e.g., the respective set of criteria is satisfied when high-value features are detected in the visual content); and the respective set of criteria includes a requirement that the second criterion is satisfied in order for the respective set of criteria to be satisfied (e.g., the second criterion is a necessary criterion of the respective set of criteria). Conditionally providing an indication of detected features if a gesture is not detected within a period of time and if the detected features include certain high-value features performs an operation when a set of conditions has been met (e.g., when the particular feature is detected in the physical environment) without requiring further user input, provides improved visual feedback to the user, and provides improved control of computer system functionality without cluttering the user interface with additional displayed controls. For example, conditionally displaying the indication of detected content surfaces visual content information to the user when the information is likely to be relevant, actionable, and/or interesting to the user, while otherwise avoiding cluttering the display.

In some embodiments, the relevance value associated with the one or more features detected within the visual content is based on (e.g., at least in part) one or more actions (e.g., operations and/or actionable intents) associated with (e.g., available to be performed using, based on, and/or with respect to) the one or more features detected within the visual content (e.g., as described with respect to FIGS. 6B, 6D, and/or 6O). For example, the computer system identifies actions available to be performed by the computer system based on and/or with respect to automatically-recognized visual content, such as identifying the action of performing a visual search to identify a location based on detected landscape features or identifying actions for providing device controls with respect to detected home automation devices. In some embodiments, detected features associated with actions that are relevant to the user (e.g., actions previously and/or frequently requested by the user), relevant to the current context (e.g., actions that are likely to be performed given the current location, time, and/or circumstances), and/or identified with a high degree of confidence are associated with higher relevance values. Determining whether the detected features include high-value features based on the quality of actions available to be performed based on the detected features performs an operation when a set of conditions has been met (e.g., when the particular feature is detected in the physical environment) without requiring further user input.

In some embodiments, the relevance value associated with the one or more features detected within the visual content is based on visual prominence of the one or more features within the visual content (e.g., as described with respect to FIG. 6B). For example, detected features that are displayed at a larger size (e.g., over a threshold size and/or relative to other features) and/or occupying larger portions of the display area (e.g., over a threshold proportion and/or relative to other features) are associated with higher relevance values than smaller detected features. Determining whether the detected features include high-value features based on the visual prominence of the detected features performs an operation when a set of conditions has been met (e.g., when the particular feature is detected in the physical environment) without requiring further user input.

In some embodiments, the indication (e.g., 614A, 654A, 654B, and/or 654C) of the one or more features detected within the visual content is displayed after (in some embodiments, at least a second threshold period of time after) displaying the prompt (e.g., 612 and/or 638) to use the gesture input to indicate the region of interest within the visual content (e.g., as described with respect to FIGS. 6B-6D and/or 6H-6O). Initially displaying the gesture prompt and later displaying the indication of detected features provides improved visual feedback to the user and provides improved control of computer system functionality without cluttering the user interface with additional displayed controls, for example, by updating the user interface in a way that progressively guides the user to different ways to interact with the visual content (e.g., using visual analysis operations).

In some embodiments, in accordance with the determination that the respective set of criteria is satisfied, the computer system ceases displaying the prompt (e.g., 612 and/or 638) to use the gesture input to indicate the region of interest within the visual content, wherein the indication (e.g., 614A, 654A, 654B, and/or 654C) of the one or more features detected within the visual content is displayed (e.g., at least partially) in a display region formerly occupied by the prompt to use the gesture input to indicate the region of interest within the visual content (e.g., as illustrated in FIGS. 6H-6J and 6O) (e.g., displaying the indication of the detected features replaces the gesture prompt). Initially displaying the gesture prompt, then replacing it with the indication of detected features provides improved visual feedback to the user and provides improved control of computer system functionality without cluttering the user interface with additional displayed controls, for example, by updating the user interface in a way that progressively guides the user to different ways to interact with the visual content (e.g., using visual analysis operations).

In some embodiments, the computer system animates, via the one or more display generation components, the prompt to use the gesture input to indicate a region of interest within the visual content (e.g., as illustrated in FIGS. 6B-6C). For example, animating the prompt includes changing the size, color, opacity, brightness, and/or other visual characteristics of the prompt over time. In some embodiments, animating the prompt includes decreasing and/or increasing the visual prominence of the prompt, e.g., until the indication of the one or more detected features is displayed. Animating the prompt to use the gesture input provides improved visual feedback to the user, for example, by intuitively drawing the user's attention to the prompt and/or directing the user's attention to other user interface content.

In some embodiments, while displaying the indication (e.g., 614A, 654A, 654B, and/or 654C) of the one or more features detected within the visual content, wherein the indication of the one or more features detected within the visual content includes a first subset of a plurality of representations (e.g., text, icons, graphical elements, and/or graphical user interface objects) of the one or more features detected within the visual content (e.g., as illustrated in FIG. 6Q) (in some embodiments, the plurality of representations includes multiple representations of the same detected feature and/or representations of multiple different detected features), the computer system detects, via the one or more input devices, an input of a respective type (e.g., 658) (e.g., a particular touch, stylus, hardware button, and/or air gesture input and/or sequence of inputs, such as a swipe gesture in a particular direction) directed to the indication of the one or more features detected within the visual content. In some embodiments, in response to detecting the input (e.g., 658) of the respective type directed to the indication of the one or more features detected within the visual content, the computer system displays (e.g., updating displaying), via the one or more display generation components, the indication of the one or more features detected within the visual content with a second subset of the plurality of representations of the one or more features detected within the visual content, wherein the second subset is different from the first subset (e.g., as illustrated in FIG. 6R) (e.g., one or more representations displayed in the first subset are not displayed in the second subset and/or one or more representations displayed in the second subset are not displayed in the first subset). For example, the indication of the one or more features includes a navigable (e.g., scrollable) menu of representations of detected features. Providing different indications of features detected in the visual content in response to a user input (e.g., a swipe) directed to the indications provides improved control of computer system functionality without cluttering the user interface with additional displayed controls.

In some embodiments, while displaying the prompt (e.g., 612 and/or 638) to use the gesture input to indicate the region of interest within the visual content, the computer system displays, via the one or more display generation components, one or more selectable user interface objects (e.g., 608C, 608D, 636C, and/or 636D) for performing one or more respective visual analysis operations using one or more remote (e.g., to the computer system; in some embodiments, cloud-based and/or server-based) services (e.g., as illustrated in FIGS. 6B-6E and/or 6H-6J). In some embodiments, the one or more selectable user interface objects for performing one or more respective visual analysis operations using one or more remote services includes an option for initiating a dialog-based interaction (e.g., a chat and/or digital assistant session) based on the visual content. In some embodiments, the one or more selectable user interface objects for performing one or more respective visual analysis operations using one or more remote services includes an option for performing a search based on the visual content (e.g., a reverse image search). In some embodiments, in accordance with a determination that the respective set of criteria is satisfied (e.g., while displaying the indication of detected features), the computer system maintains displaying the one or more selectable user interface objects (e.g., 608C, 608D, 636C, and/or 636D) for performing the one or more respective visual analysis operations using the one or more remote services (e.g., as illustrated in FIGS. 6D-6E, 6O, and/or 6Q-6R). In some embodiments, in response to detecting, via the one or more input devices, a respective input selecting a selectable user interface option, initiating a process for performing a respective visual analysis operation using a respective remote service, including, for example, displaying a prompt requesting user authorization for using the respective remote service; displaying an input field (e.g., a text input field) for inputting a user-provided prompt (e.g., a dialog input, such as a question, request, and/or command); transmitting the visual content, information about the visual content, a user-provided prompt, and/or contextual information to the respective remote service; obtaining, from the respective remote service, results of the respective visual analysis operation; and/or presenting, via the one or more display generation components and/or other output devices, the results of the respective visual analysis operation and/or information associated with performing the respective visual analysis operation. Displaying persistent options for performing visual analysis operations using one or more remote services provides improved visual feedback to the user, for example, indicating further options for interacting with the visual content that do not require either the gesture input or the satisfaction of the respective set of criteria.

In some embodiments, the visual content includes a respective screenshot (e.g., 636A) (e.g., image data representing respective content as the respective content was displayed via one or more display generation components). Providing the gesture prompt and conditionally providing the indication of detected features for visual content including a screenshot provides improved visual feedback to the user and reduces the number of inputs needed to perform an operation, which reduces the power usage and improves the battery life of the computer system by enabling the user to use the device more quickly and efficiently. For example, by displaying the gesture prompt and/or indications of detected content for the screenshot, the computer system assists users with interacting with visual content from a variety of sources (e.g., screenshots of different applications, user interfaces, and/or media) without needing to spend additional time and provide additional inputs to seek out visual analysis capabilities.

In some embodiments, displaying the visual content (e.g., 636A) and displaying the prompt (e.g., 612 and/or 638) to use the gesture input to indicate the region of interest within the visual content are performed in response to detecting, via the one or more input devices, a sequence of one or more inputs (e.g., 634) corresponding to a request (e.g., a user input, such as a hardware button press, combination of hardware button presses, a selection of a displayed user interface option, and/or a speech input) to capture the respective screenshot (e.g., as illustrated in FIGS. 6G-6H) (e.g., the process for displaying the gesture prompt and, if the respective criteria are satisfied, the indication of detected features is performed automatically in response to taking a screenshot). In some embodiments, the persistent option(s) for performing one or more visual analysis operations using the one or more remote services is also automatically displayed in response to detecting the request to capture the respective screenshot. Automatically providing the gesture prompt and conditionally providing the indication of detected features for a screenshot after capturing the screenshot provides improved visual feedback to the user and reduces the number of user inputs needed to perform an operation, for example, by automatically surfacing options for performing visual analysis operations with a captured screenshot without requiring the user to spend additional time and provide additional inputs to seek out visual analysis capabilities.

In some embodiments, the computer system displays, via the one or more display generation components, the visual content within an editing user interface (e.g., 636), wherein the editing user interface includes at least a first editing user interface object (e.g., 636E) (e.g., an affordance and/or selectable option) that, when selected, initiates a process for modifying the visual content (e.g., as illustrated in FIG. 6O-6P) (e.g., cropping, marking up, and/or modifying visual characteristics (e.g., brightness, contrast, saturation, hue, filter effects, live photo effects, and/or simulated depth-of-field effects) of the visual content). In some embodiments, the editing user interface is a media editing user interface, such as an editing user interface accessible via a media application (e.g., a media library). In some embodiments, the editing user interface is a screenshot editing user interface, such as a screenshot user interface displayed automatically after taking a screenshot.

In some embodiments, while displaying the visual content within the editing user interface (e.g., 636) and displaying at least a first user interface object (e.g., 636C, 636D, 654A, 654B, and/or 654C) (e.g., an affordance and/or selectable option) for performing a first visual analysis operation on the visual content (in some embodiments, the gesture prompt; in some embodiments, the indication of detected features; in some embodiments, a persistent option for performing a visual analysis operation using a remote service) at a first location within the editing user interface, the computer system detects, via the one or more input devices, a sequence of one or more inputs (e.g., 656) corresponding to a request (e.g., a touch, stylus, hardware input device, speech, and/or air gesture input and/or sequence of inputs) to mark up (e.g., annotate with text, drawing, and/or highlighting) the visual content (e.g., as illustrated in FIG. 6O). In some embodiments, the request to mark up the visual content includes an input directed to a markup option included in the one or more options for performing processes for modifying the visual content. In some embodiments, in response to detecting the sequence of one or more inputs (e.g., 656) corresponding to the request to mark up the visual content, the computer system ceases displaying the at least first user interface object (e.g., 636C, 636D, 654A, 654B, and/or 654C) for performing the first visual analysis operation on the visual content, and displays, via the one or more display generation components, a first set of one or more user interface objects (e.g., 636G) (e.g., affordance and/or selectable options) for marking up the visual content (e.g., markup tools, such as options for selecting a highlighter tool, pencil tool, pen tool, marker tool, and/or text tool) at the first location within the editing user interface (e.g., as illustrated in FIG. 6P) (e.g., the markup tools replace the visual analysis content, such as the gesture prompt, indications of detected features, and/or remote service options, within the editing user interface). Replacing options for visual analysis of the visual content with options for markup up the visual content provides improved control of computer system functionality without cluttering the user interface with additional displayed controls.

In some embodiments, while displaying the visual content within the editing user interface (e.g., 636) and displaying a second set of one or more user interface objects (e.g., 636G) (e.g., affordances and/or selectable options) for marking up the visual content (in some embodiments, the second set of options for marking up the visual content is the same as the first set of options for marking up the visual content) at a second location within the editing user interface, the computer system detects, via the one or more input devices, a sequence of one or more inputs (e.g., 657B) corresponding to a request (e.g., a touch, stylus, hardware input device, speech, and/or air gesture input and/or sequence of inputs) to dismiss the second set of one or more user interface objects for marking up the visual content (e.g., as illustrated in FIG. 6P). In some embodiments, the request to dismiss the options for marking up the visual content includes an input directed to an option to save current markup of the visual content item, an option to cancel the current markup of the visual content item, and/or an option to display visual analysis tools. In some embodiments, in response to detecting the sequence of one or more inputs (e.g., 657B) corresponding to the request to dismiss the second set of one or more user interface objects (e.g., 636G) for marking up the visual content, the computer system ceases displaying the second set of one or more user interface objects for marking up the visual content and displays, via the one or more display generation components, at least a second user interface object (e.g., 636C, 636D, 654A, 654B, and/or 654C) (e.g., an affordance and/or selectable option; in some embodiments, the second user interface object is the same as the at least first user interface object) for performing a second visual analysis operation on the visual content (in some embodiments, the gesture prompt; in some embodiments, the indication of detected features; in some embodiments, a persistent option for performing a visual analysis operation using a remote service) at the second location within the editing user interface (e.g., as illustrated in FIG. 6Q) (e.g., the visual analysis content replaces the markup tools when the markup tools are dismissed). Replacing options for markup of the visual content with options for visual analysis of the visual content provides improved control of computer system functionality without cluttering the user interface with additional displayed controls.

In some embodiments, the visual content includes a respective photo media item (in some embodiments, still (e.g., single-frame) photo media; in some embodiments, photo media with a limited (e.g., 0.5 s, 1 s, 3 s, and/or 5 s) duration, such as a multi-frame capture that includes content (e.g., frames) from before and/or after a capture input is detected, creating a “live” effect). Providing the gesture prompt and conditionally providing the indication of detected features for visual content including a photo media item provides improved visual feedback to the user and reduces the number of inputs needed to perform an operation. For example, by displaying the gesture prompt and/or indications of detected content for a photo media item, the computer system assists users with interacting with media content without needing to spend additional time and provide additional inputs to seek out visual analysis capabilities.

In some embodiments, the one or more input devices include one or more cameras (e.g., 606A, 606B, 606C, and/or 606D) (e.g., one or more rear (e.g., user-facing) cameras, one or more forward (e.g., environment-facing) cameras and/or one or more cameras with different lenses/lens types, such as a standard camera, a telephoto camera, and/or a wide-angle camera), and the visual content includes a representation of at least a portion of a field-of-view of (e.g., detected and/or captured by) the one or more cameras (e.g., 608A) (e.g., a live or near-live camera preview/viewfinder). In some embodiments, the visual content including the representation of the field-of-view of the one or more cameras is displayed in a camera user interface (e.g., a user interface for capturing media, such as photo and/or video media, using the one or more cameras). Providing the gesture prompt and conditionally providing the indication of detected features for visual content including a live or near-live camera preview improves visual feedback to the user and reduces the number of inputs needed to perform an operation. For example, by displaying the gesture prompt and/or indications of detected content for a camera preview, the computer system assists users with interacting with the environment via the cameras without needing to first capture the camera data as a media item and/or spend additional time and provide additional inputs to seek out visual analysis capabilities. Doing so also reduces storage space used by the computer system, for example, by assisting users with performing visual analysis operations on content captured by the cameras without needing to capture the camera data as a media item.

In some embodiments, while displaying the visual content (e.g., 608A and/or 636A) and the indication (e.g., 614A, 654A, 654B, and/or 654C) of the one or more features detected within the visual content, the computer system detects, via the one or more input devices, a respective input (e.g., a touch, stylus, hardware input device, speech, and/or air gesture input and/or sequence of inputs). In some embodiments, in response to detecting the respective input and in accordance with a determination that the respective input includes a gesture input indicating a region of interest within the visual content, the computer system displays a user interface that includes information associated with the region of interest within the visual content indicated by the gesture. In response to detecting the respective input and in accordance with a determination that the respective input includes a selection of the indication of the one or more features detected within the visual content (e.g., 616A and/or 660), the computer system displays, via the one or more display generation components, a respective user interface (e.g., 620) (in some embodiments, a visual analysis user interface, such as described with respect to FIG. 8) that includes information associated with at least one of the one or more features detected within the visual content (e.g., as illustrated in FIGS. 6F and/or 6S). For example, the respective user interface includes information about the at least one detected feature, options for performing one or more visual analysis operations based on the at least one detected feature, results of performing one or more visual analysis operations based on the at least one detected feature, and/or options for performing one or more actions with respect to the at least one detected feature. In some embodiments, the indication of detected features includes at least a first option associated with a first feature of the one or more features and a second option associated with a second feature of the one or more features that is different from the first feature, and the respective user interface includes: in accordance with a determination that the selection was directed to the first option, information associated with the first feature; and, in accordance with a determination that the selection was directed to the second option, information associated with the second feature. In some embodiments, the respective user interface is a same or similar user interface to a user interface displayed in response to detecting a gesture indicating a region of interest, but the specific information included in the user interface is based on the detected input (e.g., as described with respect to FIGS. 6F and/or 6K). Providing additional information about at least one detected feature within displayed visual content in response to detecting a selection of the indication of the detected feature(s) provides improved control of computer system functionality without cluttering the user interface with additional displayed controls and performs an operation when a set of conditions has been met (e.g., when a particular interaction with the visual content is detected) without requiring further user input. For example, the additional information related to the at least one detected feature is only displayed in response to a user request (e.g., selecting the indication), and the additional information is automatically tailored to a particular detected feature based on the selected indication without the user needing to provide additional inputs specifying a feature or portion of the visual content.

In some embodiments, while displaying the visual content (in some embodiments, while displaying the gesture prompt; in some embodiments, while displaying the indication of detected features), the computer system detects, via the one or more input devices, a first gesture input (e.g., 616B and/or 640) indicating a first region of interest within the visual content (e.g., as illustrated in FIGS. 6E and/or 6I). For example, the first gesture input includes a touch input with movement directed to the displayed visual content, such as a scribble moving across the first region of interest and/or a loop or partial loop moving around a boundary of the first region of interest. In some embodiments, in response to detecting the first gesture input (e.g., 616B and/or 640) (in some embodiments, during (e.g., in response to detecting initiation of the first gesture input) and/or after (e.g., in response to detecting an end of the first gesture input) detecting the first gesture input), the computer system displays, via the one or more display generation components, visual feedback (e.g., 618A, 618B, 618C, and/or 642) indicating the first region within the visual content (e.g., as illustrated in FIGS. 6E-6F and/or 6J). In some embodiments, the visual feedback is updated while detecting the first gesture input. For example, the visual feedback indicates the movement of the first gesture input, such as a visual output that follows and/or trails behind a location of a touch input. In some embodiments, the visual feedback is updated in response to detecting cessation of the first gesture input. Displaying visual feedback indicating the first region within the visual content provides improved visual feedback to the user, for example, by visually indicating the region of interest within the visual content that the computer system will use to perform one or more visual analysis operations (e.g., automatically and/or in response to a user input, for instance, via a visual analysis user interface such as described with respect to [link to CS2]).

In some embodiments, displaying the visual feedback indicating the first region within the visual content includes displaying, via the one or more display generation components, a respective visual element (e.g., a visual indication of the gesture path and/or the first region and/or the visual content within the first region) at a respective brightness level, wherein displaying the respective visual element at the respective brightness level expands a dynamic range of content displayed via the one or more display generation components (e.g., as described with respect to FIGS. 6E-6F) (e.g., the respective visual element is high dynamic range (HDR)/extended dynamic range (EDR) content). For example, while displaying the visual feedback, the brightness of light emitted by the one or more display generation components (e.g., at least for the display of the visual feedback) is greater than the brightness of the light that would be emitted by the one or more display generation components if the first gesture input were not detected. In some embodiments, the respective brightness level is a level that is brighter than a range of brightness used to display the visual content such that the visual element stands out from the visual content.

In some embodiments, displaying the visual feedback indicating the first region within the visual content includes displaying (in some embodiments, after detecting cessation of the first gesture input), via the one or more display generation components, a respective visual element (e.g., 618B) that represents a border (e.g., one or more edges) of a respective feature detected within the first region within the visual content, wherein one or more colors of the respective visual element change through a plurality of colors (e.g., repeatedly change from one color to another color within an ordered set of colors one or more times) while the respective visual element is displayed (e.g., as described with respect to FIG. 6F). For example, the colors of the border cycle or shuffle through the plurality of colors, optionally repeating through the plurality of colors multiple times. In some embodiments, the computer system detects, identifies, and/or selects the respective feature based on the first gesture input (e.g., the computer system identifies one or more candidate subjects within the region indicated by the user input). In some embodiments, the border of the respective feature is determined using one or more visual analysis techniques (e.g., edge detection). In some embodiments, the colors and/or cycle of colors used for the border are the same as or similar to the colors and/or cycle of colors used for a digital assistant indicator and/or a visual analysis interface.

In some embodiments, displaying the visual feedback indicating the first region within the visual content includes displaying, via the one or more display generation components, a respective visual element (e.g., 618A and/or 642) with a shape based on a path of the first gesture input. For example, the visual element includes a “blob” shape of a form drawn and/or enclosed by the first gesture input. For example, the shape overlays the visual content with one or more opaque, translucent, and/or semi-transparent colors, animations, and/or effects (e.g., filters and/or visual modifications to the underlying visual content). In some embodiments, the visual element is updated while the first gesture input is detected, for example, following the user's finger on a touch-screen display as the gesture input is performed. In some embodiments, the outer borders of the shape represent the outer borders of the first region of interest (e.g., the visual content overlaid by the blob is the portion of visual content used for visual analysis operations in response to the first gesture input). In some embodiments, the outer borders of the shape are displayed with a color-cycling border element.

In some embodiments, displaying the visual feedback indicating the first region within the visual content includes displaying, via the one or more display generation components, a respective visual element (e.g., a visual indication of the gesture path and/or the first region) with one or more colors that are selected based on one or more colors detected within the visual content (e.g., as described with respect to FIGS. 6E-6F) (in some embodiments, within the first region and/or a region proximate to the first region). For example, the visual feedback visually blends with the visual content.

In some embodiments, displaying the visual feedback indicating the first region within the visual content includes displaying (in some embodiments, after detecting cessation of the first gesture input), via the one or more display generation components, a respective visual element (e.g., 618C) that includes a symbolic representation (e.g., an icon, label, and/or tag) of a respective feature detected within the first region within the visual content (e.g., as illustrated in FIG. 6F). For example, the respective visual element includes an icon indicating a type of the detected feature (e.g., a leaf icon for a detected plant feature, a paw print icon for a detected animal feature, a mug icon for a detected café feature, and/or a phone icon for detected text of a phone number). In some embodiments, the computer system displays the respective visual element including the symbolic representation in accordance with a determination that the first region includes a feature of a respective type.

In some embodiments, while displaying the visual content (e.g., 608A and/or 636A) (in some embodiments, while displaying the gesture prompt; in some embodiments, while displaying the indication of detected features), the computer system detects, via the one or more input devices, a second gesture input (e.g., 616B and/or 640) indicating a second region of interest within the visual content (in some embodiments, the second region of interest is the same as the first region of interest), wherein the second region of interest includes a first portion of the visual content and does not include a second portion of the visual content (e.g., the gesture indicates a partial region of the overall visual content). In some embodiments, in response to detecting the second gesture input (in some embodiments, during (e.g., in response to detecting initiation of the first gesture input) and/or after (e.g., in response to detecting cessation of the first gesture input) detecting the first gesture input), the computer system initiates a process for performing a respective visual analysis operation (in some embodiments, performing the respective visual analysis operation; in some embodiments, providing options for performing the visual analysis operation; in some embodiments, displaying a visual analysis user interface, such as described with respect to FIG. 8) based on the first portion of the visual content without performing the respective visual analysis operation based on the second portion of the visual content (e.g., as described with respect to FIGS. 6K-6N). For example, the computer system initiates a process for performing an image-based search (e.g., a reverse image search) and/or performing a dialog-based interaction (e.g., a chat and/or digital assistant session) based on only the indicated portion of the visual content. In some embodiments, the process for performing the respective visual analysis operation includes providing the first portion of the visual content to a service for performing the respective visual analysis operation (e.g., one or more local and/or remote services, such as described with respect to FIG. 8) without providing the second portion of the visual content to the service. Providing visual analysis based on only the portion of displayed visual content indicated via a gesture input provides the user with improved control over the security and privacy of displayed content (e.g., limiting which portions of visual content are used, including limiting which portions of visual content are provided to third-party, local, and/or remote services). For example, the gesture input allows the user to intuitively select a limited portion of the visual content to use.

Note that details of the processes described above with respect to method 700 (e.g., FIG. 7) are also applicable in an analogous manner to the methods described below. For example, method 800 optionally includes one or more of the characteristics of the various methods described above with reference to method 700. For example, the prompt to indicate a region of interest in displayed visual content and the indications of features of interest detected in the displayed visual content described with respect to method 700 provide the user with feedback on how to specify portions of the visual content to be analyzed using the visual analysis user interface described with respect to method 800. For brevity, these details are not repeated below.

FIG. 8 is a flow diagram illustrating a method for providing multiple service provider options for performing a particular visual analysis operation using a computer system, in accordance with some embodiments. Method 800 is performed at a computer system (e.g., 100, 300, 500, and/or 600) (e.g., including one or more mobile phones, personal computers, laptops, tablets, headsets, wearable devices, and/or other electronic devices) that is in communication with one or more display generation components (e.g., display controllers; touch-sensitive display systems; displays (e.g., integrated and/or connected), 3D displays, transparent displays, projectors, and/or heads-up displays) and one or more input devices (e.g., touch-sensitive surfaces, hardware input devices (e.g., a hardware button, switch, dial, stylus, keyboard, and/or mouse), cameras, microphones, gesture input devices, air gesture input devices, and/or gaze input devices). In some embodiments, the computer system is optionally in communication with one or more sensors, such as optical sensors, depth sensors, capacitive sensors, intensity sensors, motion sensors, vibration sensors, audio sensors, light sensors, temperature sensors, and/or biometric sensors. Some operations in method 800 are, optionally, combined, the orders of some operations are, optionally, changed, and some operations are, optionally, omitted.

As described below, method 800 provides an intuitive way for providing multiple service provider options for performing a particular visual analysis operation. The method reduces the cognitive burden on a user for controlling the services used for visual analysis operations, thereby creating a more efficient human-machine interface. For battery-operated computing devices, enabling a user to perform visual analysis operations faster and more efficiently conserves power and increases the time between battery charges.

The computer system detects (802), via the one or more input devices, an input (e.g., 616A, 616B, 640, and/or 660) (in some embodiments, one or more inputs such as a touch input, a button press, an air gesture, and/or a speech input) requesting additional information associated with a feature of interest within respective visual content (e.g., 608A and/or 636A) (e.g., as illustrated in FIGS. 6E, 6I, and/or 6R). In some embodiments, the input is a gesture input indicating a region of interest within the respective visual content (e.g., as described with respect to FIG. 7). In some embodiments, the input is a selection input directed to a displayed indication of an automatically-detected feature of interest within the respective visual content (e.g., as described with respect to FIG. 7). In some embodiments, the input is detected while displaying, via the one or more display generation components, the respective visual content.

In response to detecting the input (e.g., 616A, 616B, 640, and/or 660) requesting the additional information associated with the feature of interest within the respective visual content, the computer system displays (804), via the one or more display generation components, a visual analysis user interface (e.g., 620) that includes concurrently displaying (e.g., as illustrated in FIGS. 6F, 6K-6M, and/or 6S-6U) information associated with performance of a respective visual analysis operation associated with the feature of interest within the respective visual content (e.g., 622, 624, 626A, 628B, 628D, 664A, 664B, and/or 664C) and a first option (e.g., 626B and/or 628A) that, when selected (e.g., as illustrated in FIGS. 6K, 6S, and/or 6T) (e.g., based on a sequence of one or more inputs detected via the one or more input devices), initiates a process for changing a service provider (e.g., from an initially-selected (e.g., default, previously-selected, and/or automatically-selected) service provider to a different service provider) for performing (e.g., based on the feature of interest) the respective visual analysis operation (e.g., an image- and/or video-based processing operation, such as an operation implementing machine vision, machine learning, and/or generative techniques that are performed by the computer system and/or a remote computer system based on visual information). In some embodiments, the visual analysis user interface is displayed concurrently with at least a portion of the respective visual content. For example, the visual analysis user interface is displayed as a card overlaying part of the respective visual content. In some embodiments, the visual analysis user interface replaces the respective visual content on the display. In some embodiments, the information includes one or more options for causing performance of the respective visual analysis operation. In some embodiments, the information includes one or more results of a performance of the respective visual analysis operation. In some embodiments, the information includes an indication of the respective visual analysis operation, such as text (e.g., “Type to chat”), icons, and/or graphical elements (e.g., result placeholders). For example, the first option includes a menu, platter, and/or slider with selectable items (e.g., menu items, buttons, and/or slider positions) corresponding to a plurality of candidate service providers. In some embodiments, the first option includes an indication of the selected service provider (e.g., the currently-selected service provider). In some embodiments, when performing the respective visual analysis operation (e.g., automatically and/or in response to detecting a request), the computer system causes the selected service provider (e.g., the currently-selected service provider) to perform at least a portion of the respective visual analysis operation. Providing a visual analysis user interface for a feature of interest detected within visual content that provides visual analysis information and an option for selecting a service provider with which to perform visual analysis operations provides improved visual feedback to the user and provides improved control of computer system functionality without cluttering the user interface with additional displayed controls, which reduces the power usage and improves the battery life of the computer system by enabling the user to use the device more quickly and efficiently. For example, the visual analysis user interface provides the user with more detailed and/or extensive information and controls without obscuring the visual content on the display prior to the user's request. Doing so also provides the user with improved control over the security and privacy of displayed content, for example, indicating and allowing the user to choose which services (e.g., third-party, local, and/or remote services) are authorized to use for visual analysis.

In some embodiments, the visual analysis user interface includes a query input user interface object (e.g., 626A) (e.g., an affordance and/or option, such as a button, text input field, handle, slider, scrollbar, and/or menu). In some embodiments, the process for changing the service provider for performing the respective visual analysis operation changes the service provider to one of a plurality of intelligence agents, such as different digital assistants and/or large language model (LLM) chat agents. In some embodiments, while displaying the visual analysis user interface (e.g., 620) including the query input user interface object (e.g., 626A), the computer system detects, via the one or more input devices, a respective input (e.g., 648 and/or 670) (e.g., a particular touch, stylus, hardware button, speech, and/or air gesture input and/or sequence of inputs) directed to the query input user interface object (e.g., as illustrated in FIGS. 6M and/or 6U). In some embodiments, the respective input includes a selection of the dialog option. In some embodiments, the respective input includes a dialog input (e.g., text and/or speech) with a user-provided prompt (e.g., a question, request, and/or command). In some embodiments, in response to detecting the respective input selecting the query input user interface object, the computer system initiates a first visual analysis operation (in some embodiments, the first visual analysis operation is the respective visual analysis operation for which the first option changes the service provider) for generating (e.g., using one or more semantic, algorithmic, and/or machine learning models, such as a large language model (LLM)) one or more query responses (e.g., natural-language text and/or speech outputs) based on the feature of interest within the respective visual content using a currently-selected service provider (e.g., as illustrated in FIGS. 6N and/or 6V) (e.g., a digital assistant and/or chat service; in some embodiments, a default service provider, a service provider selected by the computer system, or a service provider selected via the first option for changing the service provider). For example, performing the first visual analysis operation includes generating a query response (e.g., text and/or speech) based on the feature of interest, such as a description of the feature, additional information related to the feature, and/or a response to a user-provided prompt. In some embodiments, initiating the first visual analysis operation includes displaying a query input user interface, e.g., for receiving user inputs including prompts and displaying generated query responses. Generating dialog content based on displayed content using a currently-selected service provider provides users with improved control of computer system functionality and over the security and privacy of displayed content.

In some embodiments, the visual analysis user interface (e.g., 620) includes a search user interface object (e.g., 628A and/or 628B) (e.g., an affordance and/or option, such as a button, text input field, handle, slider, scrollbar, and/or menu). In some embodiments, the search option includes a region of the visual analysis user interface that includes search results and/or search result placeholder elements. In some embodiments, the process for changing the service provider for performing the respective visual analysis operation changes the service provider to one of a plurality of visual (e.g., image-based) search providers, such as visual search providers implementing different search engines, databases, and/or visual search techniques. In some embodiments, the computer system detects, via the one or more input devices, a respective input (e.g., 644C, 646, and/or 666C) (e.g., a particular touch, stylus, hardware button, speech, and/or air gesture input and/or sequence of inputs) directed to the search user interface object. In some embodiments, the respective input includes a selection of the search option. In some embodiments, the respective input includes a gesture input swiping across a handle element of the search option in a particular direction (e.g., pulling a partial-screen visual analysis user interface displayed at the bottom of the display upwards). In some embodiments in response to detecting the respective input selecting the search user interface object, the computer system initiates a second visual analysis operation (in some embodiments, the second visual analysis operation is the respective visual analysis operation for which the first option changes the service provider) for obtaining (e.g., using one or more algorithmic and/or machine learning models, such as a machine vision model) search results (e.g., 628C, 628D, and/or 628E) (e.g., from the Internet and/or a database; in some embodiments, image search results (e.g., the search results include image content)) based on the feature of interest within the respective visual (e.g., searching for results based on one or more visual characteristics of the feature of interest) content using a currently-selected service provider (e.g., as illustrated in FIGS. 6K-6M and/or 6S-6T) (in some embodiments, a default service provider, a service provider selected by the computer system, or a service provider selected via the first option for changing the service provider). In some embodiments, the second visual analysis operation includes searching for image content similar to the feature of interest as it appears in the visual content. In some embodiments, the second visual analysis operation includes searching for additional information about the feature of interest based on the feature of interest's visual features. Performing a search based on displayed content using a currently-selected service provider provides users with improved control of computer system functionality and over the security and privacy of displayed content.

In some embodiments, the visual analysis user interface (e.g., 620) includes a set of one or more action user interface objects (e.g., 624, 664A, 664B, and/or 664C) (e.g., affordances and/or selectable options) corresponding to one or more actions available to be performed based on (e.g., with and/or with respect to) the feature of interest. For example, the one or more actions include actions such as saving the feature of interest (e.g., the portion of the respective visual content and/or information associated with the feature of interest within the respective visual content) to one or more applications, sending the feature of interest to one or more contacts, and/or adding the feature of interest to one or more lists. In some embodiments, the computer system selects one or more actions to suggest to the user (e.g., for which to provide an option in the visual analysis user interface) based on the feature of interest and/or contextual information (e.g., past user interactions, time of day, location, and/or computer system information).

In some embodiments, the feature of interest includes at least a first object detected (e.g., automatically detected; in some embodiments, by performing at least one visual analysis operation on the visual content) within the respective visual content and a second object detected within the respective visual content that is different from the first object (e.g., as illustrated in FIG. 6S). In some embodiments, while concurrently displaying the visual analysis user interface and the respective visual content, the computer system visually emphasizes the first object and the second object within the respective visual content. For example, the computer system highlights, outlines, and/or displays visual effects emphasizing the portions of the respective visual content in which the objects are represented relative to other portions of the respective visual content. In some embodiments, the set of one or more action user interface objects includes a first action user interface object (e.g., 664A) that, when selected, initiates a process for performing a first action (e.g., with and/or with respect to) based on the first object; and the set of one or more action options includes a second action user interface object (e.g., 664B) that, when selected, initiates a process for performing a second action (e.g., with and/or with respect to) based on the second object. For example, for a plant and a dog detected within the respective visual content, the computer system provides an option for saving the plant (e.g., information about the plant and/or a portion of the respective visual content corresponding to the plant) to a gardening application and an option for posting the dog (e.g., a portion of the respective visual content corresponding to the plant) to a social media application. In some embodiments, the first action and the second action are the same action. For example, the computer system provides an option for sending the plant to a contact and an option for sending the dog to a contact. In some embodiments, the method further comprises: while displaying the set of one or more action options, detecting, via the one or more input devices, a respective input; and in response to detecting the respective input: in accordance with a determination that the respective input is directed to the first action option, initiating the process for performing the first action based on the first object, and, in accordance with a determination that the respective input is directed to the second action option, initiating the process for performing the second action based on the second object.

In some embodiments, in response to detecting the input (e.g., 616A, 616B, 640, and/or 660) requesting the additional information associated with the feature of interest within the respective visual content, the computer system causes performance of the respective visual analysis operation (e.g., the respective visual analysis operation is automatically performed by the computer system and/or a remote service) using a currently-selected service provider (e.g., as illustrated in FIGS. 6R-6S) (in some embodiments, a default service provider, a service provider selected by the computer system, or a service provider selected via the first option for changing the service provider), wherein displaying the visual analysis user interface in response to detecting the input requesting the additional information associated with the feature of interest within the respective visual content includes displaying, via the one or more display generation components, a representation (e.g., 628D) of one or more results of the performance of the respective visual analysis operation. For example, the computer system obtains the results from the currently-selected service provider. In some embodiments, the results include dialog automatically generated based on the feature of interest. In some embodiments, the results include automatically-obtained search results based on the feature of interest. Automatically providing results of a visual analysis operation in the visual analysis user interface when the visual analysis user interface is displayed provides improved visual feedback to the user and performs an operation when a set of conditions has been met (e.g., when a user input corresponding to a request for additional information is detected) without requiring further user input, which reduces the power usage and improves the battery life of the computer system by enabling the user to use the device more quickly and efficiently. For example, by automatically presenting the results of a visual analysis operation in response to the user request, the computer system demonstrates the visual analysis operation and efficiently provides the user with desirable information, while the first option displayed in the visual analysis user interface provides information about the service that provided the results and allows the user to adjust performance of the operation (e.g., to obtain results from a different service provider).

In some embodiments, the input requesting additional information associated with the feature of interest within the respective visual content includes a respective gesture input (e.g., 616B and/or 640) (e.g., a touch, stylus, and/or air gesture input and/or sequence of inputs), wherein the respective gesture input is directed to (e.g., the input is detected at, passing through, and/or looping around) a region of the respective visual content that includes the feature of interest (e.g., as illustrated in FIGS. 6E and/or 6I). For example, the respective gesture input indicates a region of interest within the visual content, as described with respect to FIG. 7. In some embodiments, the computer system identifies the feature of interest based on the respective gesture input, for instance, using one or more visual analysis operations to detect a recognized and/or high-value object within the portion of the visual content indicated by the gesture. Displaying the visual analysis user interface for the feature of interest in response to a gesture input indicating the feature of interest within the visual content provides improved visual feedback to the user and reduces the number of inputs needed to perform operations, which reduces the power usage and improves the battery life of the computer system by enabling the user to use the device more quickly and efficiently. For example, a gesture input allows users to efficiently and intuitively specify portions and/or features of the visual content to request additional information about, without needing to provide numerous inputs specifying the context of the feature of interest to the computer system, which also allows the computer system to present the visual analysis user interface with targeted information and options based on the portion of visual content specified by the gesture.

In some embodiments, prior to detecting the input requesting additional information associated with the feature of interest within the respective visual content (in some embodiments, while displaying, via the one or more display generation components, the respective visual content), the computer system displays, via the one or more display generation components, an indication (e.g., 614A, 654A, 654B, and/or 654C) of one or more features detected within the visual content that includes a respective indication of the feature of interest (in some embodiments, a conditionally-displayed indication of automatically-detected features, such as described with respect to FIG. 7), wherein the input requesting additional information associated with the feature of interest within the respective visual content includes a respective input (e.g., 616A and/or 660) directed to the respective indication of the feature of interest (e.g., as illustrated in FIGS. 6E and/or 6R). Displaying the visual analysis user interface for the feature of interest in response to an input selecting an automatic indication of the feature of interest provides improved visual feedback to the user and reduces the number of inputs needed to perform operations, for example, by indicating automatically-detected features (e.g., features of the visual content for which visual intelligence operations are available and/or relevant) to the user and allowing the user to quickly access additional information and controls for a specific feature without needing to provide additional inputs specifying the feature.

In some embodiments, the input (e.g., 616A, 616B, 640, and/or 660) requesting the additional information associated with the feature of interest within the respective visual content is detected while displaying, via the one or more display generation components, the respective visual content in a respective user interface that is included in a set of two or more user interfaces (e.g., 608 and/or 636) for which visual analysis operations are available (e.g., the visual analysis user interface is available when viewing visual content in any of the set of two or more user interfaces). For example, the visual analysis user interface is displayed in response to requests received while displaying a media item in a media user interface (e.g., a media library, media viewing application, and/or media editing application), a screenshot in a screenshot user interface, and/or a representation of a field-of-view of one or more cameras (e.g., a camera viewfinder) in a camera user interface. Displaying the visual analysis user interface for the feature of interest within visual content viewed within one of a plurality of user interfaces (e.g., a media user interface, screenshot user interface, or camera user interface) reduces the number of inputs needed to perform operations, for example, by providing the user with access to the visual intelligence user interface from various entry points without the user needing to navigate away from the user interface to a different user interface or application, providing a more seamless experience using the visual analysis features with different types and sources of visual content (e.g., visual content from a media library, screenshot, and/or captured using one or more cameras).

In some embodiments, the one or more input devices include one or more cameras (e.g., 606A, 606B, 606C, and/or 606D) (e.g., one or more rear (e.g., user-facing) cameras, one or more forward (e.g., environment-facing) cameras and/or one or more cameras with different lenses/lens types, such as a standard camera, a telephoto camera, and/or a wide-angle camera) and the respective visual content includes a representation (e.g., 608A) of a field-of-view of (e.g., detected and/or captured by) the one or more cameras (e.g., a live or near-live camera preview/viewfinder). In some embodiments, while concurrently displaying the respective visual content, including the representation of the field-of-view of the one or more cameras (e.g., 608A), and a selectable capture object (e.g., 608B) (e.g., a shutter button; in some embodiments, included in a camera user interface), the computer system displays, via the one or more display generation components, an indication (e.g., 614A, 654A, 654B, and/or 654C) of one or more features detected within the representation of the field-of-view of the one or more cameras that includes a respective indication of the feature of interest (in some embodiments, a conditionally-displayed indication of automatically-detected features, such as described with respect to FIG. 7), wherein displaying the indication of the one or more features detected within the representation of the field-of-view of the one or more cameras includes animating the indication of the one or more features emerging from the selectable capture object (e.g., as illustrated in FIG. 6D). For example, indications of automatically-detected features pop or expand out from the shutter button for the camera user interface. In some embodiments, the indication of the detected features overlays a portion of the representation of the field-of-view of the one or more cameras. In some embodiments, while displaying the indication of the one or more features detected within the representation of the field-of-view of the one or more cameras, the computer system detects, via the one or more input devices, a respective input (e.g., 616C) (e.g., a touch, stylus, hardware input device, speech, and/or air gesture input and/or sequence of inputs) and, in response to detecting the respective input and in accordance with a determination that the respective input is detected to the selectable capture object, capturing, via the one or more cameras, a media item (e.g., photo and/or video media) representing the field-of-view of the one or more cameras (e.g., as described with respect to FIG. 6D). In some embodiments, in accordance with a determination that the respective input is directed to the indication of detected features (e.g., a respective indication corresponding to the feature of interest), the computer system displays the visual analysis user interface as described above. In some embodiments, in accordance with a determination that the respective input includes a gesture input directed to the respective visual content (e.g., the camera preview/viewfinder), the computer system displays the visual analysis user interface as described above (e.g., based on the gesture). Displaying an indication of features detected in the field-of-view of one or more cameras emerging from a user interface object for capturing media using the one or more cameras provides improved visual feedback to the user, for example, by automatically indicating additional information about and/or options for interacting with visual content via a camera user interface beyond capturing media. Doing so also reduces the risk that transient visual content (e.g., features of the physical environment captured using a live camera feed) is missed by presenting both the capture option and the indication of detected features together, allowing the user to quickly and intuitively navigate between options without needing to spend additional time and effort seeking out different controls.

In some embodiments, the input requesting the additional information associated with the feature of interest within the respective visual content includes a selection (e.g., 616A) (e.g., a sequence of one or more inputs detected via the one or more input devices) of the respective indication of the feature of interest detected within the representation of the field-of-view of the one or more cameras (e.g., as illustrated in FIG. 6D). For example, the computer system displays the visual analysis user interface as described above in response to detecting an input selecting the indication of the feature of interest that emerged from the shutter button.

In some embodiments, while displaying the visual analysis user interface (e.g., 620) (e.g., while initially displaying the visual analysis user interface in response to the input requesting the additional information), the computer system detects, via the one or more input devices, a gesture input (e.g., 646 and/or 666C) that includes movement in a respective direction (e.g., a swipe, drag, and/or scroll gesture moving up, down, left, right, and/or another direction) across the visual analysis user interface. In some embodiments, the gesture input is directed to a particular portion and/or object within the visual analysis user interface, such as a handle element (e.g., a visual element indicating that a partial-screen visual analysis user interface (e.g., card) can be “pulled” further onto the display to view additional content), scroll bar, and/or result placeholder. In some embodiments, in response to detecting the gesture input that includes the movement in the respective direction across the visual analysis user interface, the computer system displays, via the one or more display generation components, a representation (e.g., 628C and/or 628E) of one or more results of a performance of the respective visual analysis operation using a currently-selected service provider (in some embodiments, the computer system causes the performance of the respective visual analysis operation in response to detecting the gesture input (e.g., the computer system foregoes obtaining the results until the gesture is detected); in some embodiments, the computer system causes the performance of the respective visual analysis operation prior to detecting the gesture input, but foregoes presenting the results until the gesture is detected), wherein the representation of the one or more results of the performance of the respective visual analysis operation was not displayed prior to detecting the gesture input (e.g., as illustrated in FIGS. 6L-6M and/or 6S-6T). In some embodiments, the results include dialog automatically generated based on the feature of interest. In some embodiments, the results include search results based on the feature of interest. In some embodiments, the results are presented within the visual analysis user interface (e.g., the visual analysis user interface is populated with search results). In some embodiments, the results are presented within a user interface other than the visual analysis user interface (e.g., the computer system launches a dialog user interface for a digital assistant and/or chat service). Providing results of a visual analysis operation only in response to a gesture input in a particular direction performs an operation when a set of conditions has been met (e.g., when a gesture input in the proper direction is detected) without requiring further user input. Doing so also improves computer system efficiency by foregoing certain power-intensive processes, such as performing visual analysis and/or presenting visual analysis results, until explicitly requested by the user, which allows the user to check the visual analysis settings, such as the feature of interest to be analyzed and/or the selected service provider for the visual analysis, and prevents performance of the power-intensive processes with inadvertent and/or unwanted settings.

In some embodiments, displaying the visual analysis user interface (e.g., 620) in response to detecting the input (e.g., 616A, 616B, 640, and/or 660) requesting additional information associated with the feature of interest within the respective visual content includes displaying, via the one or more display generation components, the visual analysis user interface with one or more result placeholder objects (e.g., 628B) (e.g., as illustrated in FIG. 6L). In some embodiments, the one or more result placeholder objects are displayed with a form and/or appearance similar to a form and/or appearance of the representation of the one or more results of the performance of the respective visual analysis operation. For example, the visual analysis user interface includes placeholder thumbnails for results of an image-based search that include blurred and/or grayed-out placeholder content. In some embodiments, in response to detecting the gesture input (e.g., 646) that includes the movement in the respective direction across the visual analysis user interface, the computer system ceases display of the one or more result placeholder objects (e.g., 628B), wherein the representation (e.g., 628C) of the one or more results of the performance of the respective visual analysis operation replaces the one or more result placeholder objects within the visual analysis user interface (e.g., as illustrated in FIG. 6M). For example, the placeholder thumbnails are replaced with thumbnails of image-based search results. Displaying one or more result placeholder objects that are replaced with the results of the respective visual analysis operation provides improved visual feedback to the user, for example, by indicating what the results of the visual analysis operation will include, where the results will be presented within the visual analysis user interface, and/or how to access the results of the visual analysis operation (e.g., by scrolling and/or pulling the placeholder objects further onto the display).

In some embodiments, the visual analysis user interface includes a plurality of selectable user interface objects (e.g., 624, 664A, 664B, and/or 664C) (e.g., affordances and/or options) corresponding to one or more actions available to be performed based on the feature of interest. In some embodiments, while displaying the visual analysis user interface including the plurality of selectable user interface objects, the computer system detects, via the one or more input devices, a respective input (e.g., 630, 644A, and/or 644C) directed to the plurality of selectable user interface objects. In some embodiments, in response to detecting the respective input directed to the plurality of selectable user interface objects and in accordance with a determination that the respective input (e.g., 644A) is directed to a first selectable user interface object of the plurality of selectable user interface objects, the computer system provides a first representation of the feature of interest to a first application (e.g., as described with respect to FIG. 6K). In some embodiments, the first representation of the feature of interest includes a portion of the visual content corresponding to the feature of interest. In some embodiments, the first representation of the feature of interest includes information identifying, describing, and/or associated with the feature of interest (e.g., visual context information determined based on the visual content). In some embodiments, providing a representation of the feature of interest to an application causes the application to perform an operation using the representation, such as sending a message or email to a contact based on the representation, adding content based on the representation to a note or document, performing a search based on the representation, and/or setting up a reminder based on the representation. In some embodiments, in response to detecting the respective input directed to the plurality of selectable user interface objects and in accordance with a determination that the respective input (e.g., 644B) is directed to a second selectable user interface object of the plurality of selectable user interface objects, the computer system provides a second representation of the feature of interest (in some embodiments, the second representation of the feature of interest is the same as the first representation or different from the first representation) to a second application that is different from the first application (e.g., as described with respect to FIG. 6K). In some embodiments, in accordance with a determination that the respective input is directed to another selectable option of the plurality of selectable options, the computer system provides a respective representation of the feature of interest to another application (e.g., other than the first or second application). In some embodiments, in accordance with a determination that the respective input is directed to another selectable option of the plurality of selectable options, the computer system performs a different action (e.g., other than providing a representation of the feature of interest to an application) based on the feature of interest. For example, the first application is a reminders application that, given a representation of an object, sets up a reminder to deliver to the user based on the object (e.g., a reminder to water a houseplant), and the second application is a notes application that, given a representation of an object, adds the representation into a new or existing note (e.g., inserting a picture or text describing the houseplant into a note). For example, the first application is a messaging application that, given a representation of an object, sends a text message with information based on the representation (e.g., a picture or text describing the object), and the second application is an email application that, given a representation of an object, sends a text message with information based on the representation.

In some embodiments, in response to detecting the input requesting the additional information associated with the feature of interest within the respective visual content and in accordance with a determination that context information representing historical user interactions (e.g., with the computer system, with visual content, and/or with the visual analysis user interface) indicates expected performance of the respective visual analysis operation, the computer system causes performance of the respective visual analysis operation (e.g., the respective visual analysis operation is automatically performed by the computer system and/or a remote service) using a currently-selected service provider (e.g., as described with respect to FIG. 6S) (in some embodiments, a default service provider, a service provider selected by the computer system, or a service provider selected via the first option for changing the service provider). In some embodiments, the context information representing historical user interactions indicates expected performance of the respective visual analysis operation if the user requested performance of the respective visual analysis operation at least a threshold number of times in the past, in contexts similar to a current context (e.g., at a similar time of day and/or similar location), and/or on previous visual content and/or a previous feature of interest similar to the respective visual content and/or feature of interest. In some embodiments, displaying the visual analysis user interface (e.g., 620) in response to detecting the input requesting the additional information associated with the feature of interest within the respective visual content includes displaying, via the one or more display generation components, a representation (e.g., 628D) of one or more results of the performance of the respective visual analysis operation (e.g., as illustrated in FIG. 6S). In some embodiments, the computer system automatically selects the currently-selected service provider based on the context information representing the historical user interactions that indicates the expected performance of the operation. For example, if the user typically and/or frequently selected a particular service provider for the previous performances of the visual analysis operation, the computer system automatically performs the visual analysis operation using that service provider. For example, the computer system obtains the results from the currently-selected service provider. In some embodiments, the results include dialog automatically generated based on the feature of interest. In some embodiments, the results include automatically-obtained search results based on the feature of interest. In some embodiments, in accordance with a determination that context information representing historical user interactions does not indicate expected performance of the respective visual analysis operation, the computer system foregoes automatically causing performance of the respective visual analysis operation and displaying the results, for example, until detecting one or more user inputs explicitly requesting the performance (e.g., an input swiping up to view results, such as described above). Automatically providing results of a visual analysis operation in the visual analysis user interface when the visual analysis user interface is displayed performs an operation when a set of conditions has been met (e.g., when past user interactions indicate that performing the visual analysis operation is likely in the current context) without requiring further user input.

In some embodiments, while displaying the visual analysis user interface, the computer system displays, via the one or more display generation components, a plurality of user interface objects (e.g., 628A and/or the expanded view of 626B) (e.g., an affordances and/or selectable options) corresponding to a respective plurality of service providers for performing the respective visual analysis operation. In some embodiments, the plurality of options is displayed in the visual analysis user interface in response to detecting the input requesting the additional information associated with the feature of interest within the respective visual content, and the first option is included in the plurality of options (e.g., the first option is an option corresponding to a first service provider, and the process for changing the service provider initiated in response to a selection of the first option changes the currently-selected service provider to the first service provider). In some embodiments, the plurality of options is displayed in response to detecting a selection of the first option (e.g., the process for changing the service provider includes displaying the plurality of options for the user to choose a service provider). For example, selecting the first option opens a menu displaying the plurality of options. In some embodiments, displaying the plurality of user interface objects corresponding to the respective plurality of service providers includes, in accordance with a determination that the feature of interest is a first type of feature, displaying a respective user interface object corresponding to a first service provider for performing the respective visual analysis operation (e.g., the service provider options for the Plant App service provider and/or the Cooking App service provider, as illustrated in FIGS. 6K-6L and 6S-6U); and, in accordance with a determination that the feature of interest is not the first type of feature, foregoing displaying the respective user interface object corresponding to the first service provider for performing the respective visual analysis operation (e.g., as illustrated in FIG. 6F). For example, if a particular type of content is detected within the visual content, the plurality of service provider options provided to the user includes a service provider associated with the particular type of content (e.g., a specialized service provider). For example, if the particular type of content is not detected within the visual content, the plurality of service provider options provided to the user does not include the service provider associated with the particular type of content. In some embodiments, the plurality of options includes one or more default service provider options, which are provided in accordance with a determination that the feature of interest is not the first type of feature and, optionally, in accordance with a determination that the feature of interest is the first type of feature. In some embodiments, in accordance with a determination that the feature of interest is a second type of feature that is different from the first type of feature, the computer system displays a user interface object corresponding to a second service provider for performing the respective visual analysis operation that is different from the first service provider. For example, the option corresponding to the second service provider is provided without the option corresponding to the first service provider (e.g., if the feature of interest is the second type of feature and not the first type of feature) or concurrently with the option corresponding to the first service provider (e.g., if the feature of interest is both the second type of feature and the first type of feature). Displaying a particular service provider option for performing the respective visual analysis operation if the feature of interest within the visual content is a particular type of feature performs an operation when a set of conditions has been met without requiring further user input, provides improved visual feedback to the user, and provides improved control of computer system functionality without cluttering the user interface with additional displayed controls. For example, the computer system automatically tailors the presented service provider options to the visual content to be analyzed (e.g., presenting certain options to the user when the service providers are likely to be used and foregoing presenting certain options when the service providers are less likely to be used), allowing the user to efficiently and intuitively browse and select between relevant service providers.

In some embodiments, in response to detecting the input (e.g., 616A, 616B, 640, and/or 660) requesting the additional information associated with the feature of interest within the respective visual content, the computer system selects a respective service provider of the respective plurality of service providers as a recommended service provider, wherein selecting the respective service provider of the respective plurality of service providers as the recommended service provider includes, in accordance with a determination that the feature of interest is the first type of feature, selecting the first service provider for performing the respective visual analysis operation as the recommended service provider (e.g., selecting the Cooking App service provider as illustrated in FIG. 6S); and, in accordance with a determination that the feature of interest is not the first type of feature, foregoing selecting the first service provider for performing the respective visual analysis operation as the recommended service provider (e.g., foregoing selecting the Plant App service provider as illustrated in FIG. 6K). In some embodiments, the computer system displays an indication of the recommended service provider. For example, the plurality of options are displayed in a ranked order (e.g., an option for the recommended service provider is displayed in a first and/or most prominent position relative to the other options). In some embodiments, the computer system initially selects the recommended service provider as a currently-selected service provider for performing the respective visual analysis operation. In some embodiments, in accordance with a determination that the feature of interest is not the first type of feature, the computer system selects a different service provider (in some embodiments, a default service provider or a second service provider that is different from the first service provider).

In some embodiments, while displaying the visual analysis user interface, the computer system detects, via the one or more input devices, a sequence of one or more inputs (e.g., 644C, 666B, and/or 668) that corresponds to a selection of the first option (e.g., as illustrated in FIGS. 6K, 6S, and/or 6T). In some embodiments, in response to detecting the sequence of one or more input that corresponds to the selection of the first option, the computer system changes a currently-selected service provider for performing the respective visual analysis operation to a first respective service provider associated with the first option (e.g., as illustrated in FIGS. 6L, 6T, and/or 6U). For example, the first option is an option associated with the first respective service provider and included in a plurality of options associated with a respective plurality of service providers that is displayed within the visual analysis user interface. In some embodiments, in response to detecting the selection of the first option, the computer system initiates performance of the respective visual analysis operation using the first respective service provider (e.g., changing the service provider causes the respective visual analysis operation to be performed using the changed service provider).

In some embodiments, while displaying the visual analysis user interface, the computer system detects, via the one or more input devices, a sequence of one or more inputs that corresponds to a selection of the first option and, in response to detecting the sequence of one or more inputs that corresponds to the selection of the first option, displays, via the one or more display generation components, a plurality of user interface objects (e.g., affordances and/or selectable options) corresponding to a respective plurality of service providers for performing the respective visual analysis operation (e.g., as described with respect to first service provider control 626B in FIG. 6T), wherein selecting a respective user interface object of the plurality of user interface objects that corresponds to a respective service provider of the respective plurality of service providers initiates a process for changing a currently-selected service provider to the respective service provider (e.g., as illustrated in FIGS. 6T-6U). For example, selecting the first option opens a menu or platter of options representing different service providers available for performing the respective visual analysis operation.

In some embodiments, while displaying the visual analysis user interface (e.g., 620), the computer system detects, via the one or more input devices, a sequence of one or more inputs (e.g., 646, 648, 666C, and/or 670) that corresponds to a request to initiate performing the respective visual analysis operation. In some embodiments, in response to detecting the sequence of one or more inputs that corresponds to the request to initiate performing the respective visual analysis operation and in accordance with a determination that, after detecting the input requesting the additional information associated with the feature of interest within the respective visual content, the process for changing the service provider for performing the respective visual analysis operation was performed (e.g., as illustrated in FIGS. 6L, 6T, and/or 6U) (e.g., if the user changed a currently-selected service provider via the first option), the computer system initiates performing the respective visual analysis operation using a changed service provider selected as a result of the process for changing the service provider for performing the respective visual analysis operation (e.g., as illustrated in FIGS. 6M, 6T, and/or 6V). In some embodiments, the changed service provider is a service provider associated with the first option. In some embodiments, the changed service provider is a service provider selected from a plurality of service provider options displayed in response to a selection of the first option. In some embodiments, in response to detecting the sequence of one or more inputs that corresponds to the request to initiate performing the respective visual analysis operation and in accordance with a determination that, after detecting the input requesting the additional information associated with the feature of interest within the respective visual content, the process for changing the service provider for performing the respective visual analysis operation was not performed (e.g., as illustrated in FIG. 6M), the computer system initiates performing the respective visual analysis operation using an initial (e.g., default and/or recommended) service provider (e.g., as illustrated in FIG. 6N). Performing the respective visual analysis operation using either a user-selected service provider or, in the absence of a user selection, a default or automatically-recommended service provider reduces the number of inputs needed to perform an operation and provides the user with improved control over the security and privacy of displayed content. For example, the visual analysis user interface allows users to quickly perform visual analysis operations using a default service provider, while the first option allows users to control which service provider(s) are used to analyze the visual content.

In some embodiments, while displaying the visual analysis user interface (e.g., 620) (e.g., while initially displaying the visual analysis user interface in response to the input requesting the additional information), the computer system detects, via the one or more input devices, a gesture input (e.g., 646 and/or 666C) that includes movement in a respective direction (e.g., a swipe, drag, and/or scroll gesture moving up, down, left, right, and/or another direction) across the visual analysis user interface (e.g., as illustrated in FIGS. 6L and/or 6S). In some embodiments, the gesture input is directed to a particular portion and/or object within the visual analysis user interface, such as a handle element (e.g., a visual element indicating that a partial-screen visual analysis user interface (e.g., card) can be “pulled” further onto the display to view additional content), scroll bar, and/or result placeholder. In some embodiments, in response to detecting the gesture input that includes the movement in the respective direction across the visual analysis user interface, the computer system initiates a performance of the respective visual analysis operation using a currently-selected service provider and displays, via the one or more display generation components, a representation (e.g., 628C and/or 628E) of one or more results of the performance of the respective visual analysis operation (e.g., as illustrated in FIGS. 6M and/or 6T). In some embodiments, the results include dialog automatically generated based on the feature of interest. In some embodiments, the results include search results based on the feature of interest. In some embodiments, the results are presented within the visual analysis user interface (e.g., the visual analysis user interface is populated with search results). In some embodiments, the results are presented within a user interface other than the visual analysis user interface (e.g., the computer system launches a dialog user interface for a digital assistant and/or chat service). Performing a visual analysis operation and displaying results thereof provides improved control of computer system functionality without cluttering the user interface with additional displayed controls, for example, by allowing users to intuitively cause performance of the visual analysis operation by swiping or scrolling the visual analysis user interface without needing to display additional user interface elements for the visual analysis operation. Doing so also improves computer system efficiency by foregoing certain power-intensive processes, such as performing visual analysis, until explicitly requested by the user, which allows the user to confirm the visual analysis settings, such as the feature of interest to be analyzed and/or the selected service provider for the visual analysis, via the visual analysis user interface and prevents performance of the power-intensive processes with inadvertent and/or unwanted settings.

In some embodiments, while displaying the visual analysis user interface and a first representation (e.g., 628D) of one or more results of a first performance of the respective visual analysis operation, wherein the first performance of the respective visual analysis operation used a third service provider, the computer system detects, via the one or more input devices, a set of one or more inputs (e.g., 666B) that includes a selection of the first option (e.g., 628A) (e.g., an input and/or sequence of inputs in response to which the computer system performs the process for changing the service provider). In some embodiments, the set of one or more inputs includes a selection of an option corresponding to a fourth service provider that is different than the third service provider. In some embodiments, in response to detecting the set of one or more inputs that includes the selection of the first option, the computer system performs the process for changing the service provider for performing the respective visual analysis operation to a fourth service provider that is different from the third service provider; initiates a second performance of the respective visual analysis operation using the fourth service provider; and displays, via the one or more display generation components, a second representation (e.g., 628E) of one or more results of the second performance of the respective visual analysis operation (e.g., as described with respect to FIGS. 6S-6T). In some embodiments, the computer system ceases displaying the first representation of the one or more results of the first performance of the respective visual analysis operation (e.g., the new results replace the results that were displayed prior to detecting the input(s) changing the service provider). Performing the respective visual analysis operation with a changed service provider and presenting the results in response to one or more inputs changing the service provider reduces the number of inputs needed to perform an operation, for example, by automatically updating the displayed results without requiring the user to provide additional inputs requesting performance of the visual analysis operation after changing the selected service provider.

Note that details of the processes described above with respect to method 800 (e.g., FIG. 8) are also applicable in an analogous manner to the methods described above. For example, method 800 optionally includes one or more of the characteristics of the various methods described above with reference to method 700. For example, the information and/or service provider options provided in the visual analysis user interface of method 800 are provided in response to and/or based on the region of interest and/or feature of interest indicated in response to the prompt and/or indication provided as described with respect to method 700. For brevity, these details are not repeated below.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

As described above, one aspect of the present technology is the gathering and use of data available from various sources to improve the performance of visual analysis operations on displayed visual content. The present disclosure contemplates that in some instances, this gathered data may include personal information data that uniquely identifies or can be used to contact or locate a specific person. Such personal information data can include demographic data, location-based data, telephone numbers, email addresses, social network IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to tailor the performance of visual analysis operations to user preferences. Accordingly, use of such personal information data enables users to have calculated control of relevant and/or personalized performance of visual analysis operations on displayed visual content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of visual analysis operations, the present technology can be configured to allow users to select to “opt in” or “opt out” of participation in the collection of personal information data during registration for services or anytime thereafter. In another example, users can select not to provide mood-associated data for visual analysis operations. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, visual analysis operations can be performed using preferences inferred based on non-personal information data or a bare minimum amount of personal information, such as the content being requested by the device associated with a user, other non-personal information available to the visual analysis operations, or publicly available information.

What is claimed is:

1. A computer system configured to communicate with one or more display generation components and one or more input devices, comprising:
one or more processors; and
memory storing one or more programs configured to be executed by the one or more processors, the one or more programs including instructions for:
detecting, via the one or more input devices, an input requesting additional information associated with a feature of interest within respective visual content; and
in response to detecting the input requesting the additional information associated with the feature of interest within the respective visual content, displaying, via the one or more display generation components, a visual analysis user interface that includes concurrently displaying:
information associated with performance of a respective visual analysis operation associated with the feature of interest within the respective visual content; and
a first option that, when selected, initiates a process for changing a service provider for performing the respective visual analysis operation.

2. The computer system of claim 1, wherein the visual analysis user interface includes a query input user interface object, the one or more programs further including instructions for:
while displaying the visual analysis user interface including the query input user interface object, detecting, via the one or more input devices, a respective input directed to the query input user interface object; and
in response to detecting the respective input selecting the query input user interface object, initiating a first visual analysis operation for generating one or more query responses based on the feature of interest within the respective visual content using a currently-selected service provider.

3. The computer system of claim 1, wherein the visual analysis user interface includes a search user interface object, the one or more programs further including instructions for:
detecting, via the one or more input devices, a respective input directed to the search user interface object; and
in response to detecting the respective input selecting the search user interface object, initiating a second visual analysis operation for obtaining search results based on the feature of interest within the respective visual content using a currently-selected service provider.

4. The computer system of claim 1, wherein the visual analysis user interface includes a set of one or more action user interface objects corresponding to one or more actions available to be performed based on the feature of interest.

5. The computer system of claim 4, wherein:
the feature of interest includes at least a first object detected within the respective visual content and a second object detected within the respective visual content that is different from the first object;
the set of one or more action user interface objects includes a first action user interface object that, when selected, initiates a process for performing a first action based on the first object; and
the set of one or more action options includes a second action user interface object that, when selected, initiates a process for performing a second action based on the second object.

6. The computer system of claim 1, the one or more programs further including instructions for:
in response to detecting the input requesting the additional information associated with the feature of interest within the respective visual content, causing performance of the respective visual analysis operation using a currently-selected service provider, wherein displaying the visual analysis user interface in response to detecting the input requesting the additional information associated with the feature of interest within the respective visual content includes:
displaying, via the one or more display generation components, a representation of one or more results of the performance of the respective visual analysis operation.

7. The computer system of claim 1, wherein the input requesting additional information associated with the feature of interest within the respective visual content includes a respective gesture input, wherein the respective gesture input is directed to a region of the respective visual content that includes the feature of interest.

8. The computer system of claim 1, the one or more programs further including instructions for:
prior to detecting the input requesting additional information associated with the feature of interest within the respective visual content, displaying, via the one or more display generation components, an indication of one or more features detected within the visual content that includes a respective indication of the feature of interest, wherein the input requesting additional information associated with the feature of interest within the respective visual content includes a respective input directed to the respective indication of the feature of interest.

9. The computer system of claim 1, wherein the input requesting the additional information associated with the feature of interest within the respective visual content is detected while displaying, via the one or more display generation components, the respective visual content in a respective user interface that is included in a set of two or more user interfaces for which visual analysis operations are available.

10. The computer system of claim 1, wherein:
the one or more input devices include one or more cameras;
the respective visual content includes a representation of a field-of-view of the one or more cameras; and
the one or more programs further including instructions for:
while concurrently displaying the respective visual content, including the representation of the field-of-view of the one or more cameras, and a selectable capture object, displaying, via the one or more display generation components, an indication of one or more features detected within the representation of the field-of-view of the one or more cameras that includes a respective indication of the feature of interest, wherein displaying the indication of the one or more features detected within the representation of the field-of-view of the one or more cameras includes animating the indication of the one or more features emerging from the selectable capture object;
while displaying the indication of the one or more features detected within the representation of the field-of-view of the one or more cameras, detecting, via the one or more input devices, a respective input; and
in response to detecting the respective input:
in accordance with a determination that the respective input is detected to the selectable capture object, capturing, via the one or more cameras, a media item representing the field-of-view of the one or more cameras.

11. The computer system of claim 10, wherein the input requesting the additional information associated with the feature of interest within the respective visual content includes a selection of the respective indication of the feature of interest detected within the representation of the field-of-view of the one or more cameras.

12. The computer system of claim 1, the one or more programs further including instructions for:
while displaying the visual analysis user interface, detecting, via the one or more input devices, a gesture input that includes movement in a respective direction across the visual analysis user interface; and
in response to detecting the gesture input that includes the movement in the respective direction across the visual analysis user interface, displaying, via the one or more display generation components, a representation of one or more results of a performance of the respective visual analysis operation using a currently-selected service provider, wherein the representation of the one or more results of the performance of the respective visual analysis operation was not displayed prior to detecting the gesture input.

13. The computer system of claim 12, wherein:
displaying the visual analysis user interface in response to detecting the input requesting additional information associated with the feature of interest within the respective visual content includes displaying, via the one or more display generation components, the visual analysis user interface with one or more result placeholder objects; and
in response to detecting the gesture input that includes the movement in the respective direction across the visual analysis user interface, ceasing display of the one or more result placeholder objects, wherein the representation of the one or more results of the performance of the respective visual analysis operation replaces the one or more result placeholder objects within the visual analysis user interface.

14. The computer system of claim 1, wherein the visual analysis user interface includes a plurality of selectable user interface objects corresponding to one or more actions available to be performed based on the feature of interest, the one or more programs further including instructions for:
while displaying the visual analysis user interface including the plurality of selectable user interface objects, detecting, via the one or more input devices, a respective input directed to the plurality of selectable user interface objects; and
in response to detecting the respective input directed to the plurality of selectable user interface objects:
in accordance with a determination that the respective input is directed to a first selectable user interface object of the plurality of selectable user interface objects, providing a first representation of the feature of interest to a first application; and
in accordance with a determination that the respective input is directed to a second selectable user interface object of the plurality of selectable user interface objects, providing a second representation of the feature of interest to a second application that is different from the first application.

15. The computer system of claim 1, the one or more programs further including instructions for:
in response to detecting the input requesting the additional information associated with the feature of interest within the respective visual content:
in accordance with a determination that context information representing historical user interactions indicates expected performance of the respective visual analysis operation:
causing performance of the respective visual analysis operation using a currently-selected service provider, wherein displaying the visual analysis user interface in response to detecting the input requesting the additional information associated with the feature of interest within the respective visual content includes:
displaying, via the one or more display generation components, a representation of one or more results of the performance of the respective visual analysis operation.

16. The computer system of claim 1, the one or more programs further including instructions for:
while displaying the visual analysis user interface, displaying, via the one or more display generation components, a plurality of user interface objects corresponding to a respective plurality of service providers for performing the respective visual analysis operation, wherein displaying the plurality of user interface objects corresponding to the respective plurality of service providers includes:
in accordance with a determination that the feature of interest is a first type of feature, displaying a respective user interface object corresponding to a first service provider for performing the respective visual analysis operation; and
in accordance with a determination that the feature of interest is not the first type of feature, foregoing displaying the respective user interface object corresponding to the first service provider for performing the respective visual analysis operation.

17. The computer system of claim 16, the one or more programs further including instructions for:
in response to detecting the input requesting the additional information associated with the feature of interest within the respective visual content, selecting a respective service provider of the respective plurality of service providers as a recommended service provider, wherein selecting the respective service provider of the respective plurality of service providers as the recommended service provider includes:
in accordance with a determination that the feature of interest is the first type of feature, selecting the first service provider for performing the respective visual analysis operation as the recommended service provider; and
in accordance with a determination that the feature of interest is not the first type of feature, foregoing selecting the first service provider for performing the respective visual analysis operation as the recommended service provider.

18. The computer system of claim 1, the one or more programs further including instructions for:
while displaying the visual analysis user interface, detecting, via the one or more input devices, a sequence of one or more inputs that corresponds to a selection of the first option; and
in response to detecting the sequence of one or more input that corresponds to the selection of the first option, changing a currently-selected service provider for performing the respective visual analysis operation to a first respective service provider associated with the first option.

19. The computer system of claim 1, the one or more programs further including instructions for:
while displaying the visual analysis user interface, detecting, via the one or more input devices, a sequence of one or more inputs that corresponds to a selection of the first option; and
in response to detecting the sequence of one or more inputs that corresponds to the selection of the first option, displaying, via the one or more display generation components, a plurality of user interface objects corresponding to a respective plurality of service providers for performing the respective visual analysis operation, wherein selecting a respective user interface object of the plurality of user interface objects that corresponds to a respective service provider of the respective plurality of service providers initiates a process for changing a currently-selected service provider to the respective service provider.

20. The computer system of claim 1, the one or more programs further including instructions for:
while displaying the visual analysis user interface, detecting, via the one or more input devices, a sequence of one or more inputs that corresponds to a request to initiate performing the respective visual analysis operation; and
in response to detecting the sequence of one or more inputs that corresponds to the request to initiate performing the respective visual analysis operation:
in accordance with a determination that, after detecting the input requesting the additional information associated with the feature of interest within the respective visual content, the process for changing the service provider for performing the respective visual analysis operation was performed, initiating performing the respective visual analysis operation using a changed service provider selected as a result of the process for changing the service provider for performing the respective visual analysis operation; and
in accordance with a determination that, after detecting the input requesting the additional information associated with the feature of interest within the respective visual content, the process for changing the service provider for performing the respective visual analysis operation was not performed, initiating performing the respective visual analysis operation using an initial service provider.

21. The computer system of claim 1, the one or more programs further including instructions for:
while displaying the visual analysis user interface, detecting, via the one or more input devices, a gesture input that includes movement in a respective direction across the visual analysis user interface; and
in response to detecting the gesture input that includes the movement in the respective direction across the visual analysis user interface:
initiating a performance of the respective visual analysis operation using a currently-selected service provider; and
displaying, via the one or more display generation components, a representation of one or more results of the performance of the respective visual analysis operation.

22. The computer system of claim 1, the one or more programs further including instructions for:
while displaying the visual analysis user interface and a first representation of one or more results of a first performance of the respective visual analysis operation, wherein the first performance of the respective visual analysis operation used a third service provider, detecting, via the one or more input devices, a set of one or more inputs that includes a selection of the first option; and
in response to detecting the set of one or more inputs that includes the selection of the first option:
performing the process for changing the service provider for performing the respective visual analysis operation to a fourth service provider that is different from the third service provider;
initiating a second performance of the respective visual analysis operation using the fourth service provider; and
displaying, via the one or more display generation components, a second representation of one or more results of the second performance of the respective visual analysis operation.

23. A non-transitory computer-readable storage medium storing one or more programs configured to be executed by one or more processors of a computer system that is in communication with one or more display generation components and one or more input devices, the one or more programs including instructions for:
detecting, via the one or more input devices, an input requesting additional information associated with a feature of interest within respective visual content; and
in response to detecting the input requesting the additional information associated with the feature of interest within the respective visual content, displaying, via the one or more display generation components, a visual analysis user interface that includes concurrently displaying:
information associated with performance of a respective visual analysis operation associated with the feature of interest within the respective visual content; and
a first option that, when selected, initiates a process for changing a service provider for performing the respective visual analysis operation.

24. A method, comprising:
at a computer system that is in communication with one or more display generation components and one or more input devices:
detecting, via the one or more input devices, an input requesting additional information associated with a feature of interest within respective visual content; and
in response to detecting the input requesting the additional information associated with the feature of interest within the respective visual content, displaying, via the one or more display generation components, a visual analysis user interface that includes concurrently displaying:
information associated with performance of a respective visual analysis operation associated with the feature of interest within the respective visual content; and
a first option that, when selected, initiates a process for changing a service provider for performing the respective visual analysis operation.
